(19) United States
(12) Patent Application Publication
(10) Pub. No.: US 2024/0255105 A1
(43) Pub. Date: Aug. 1, 2024

(54) GASEOUS HYDROGEN FUELING METHODS

(71) Applicant: FirstElement Fuel, Inc., Irvine, NC (US)

(72) Inventor: Steven Richard Mathison, Palos Verdes Estates, CA (US)

(21) Appl. No.: 18/619,716

(22) Filed: Mar. 28, 2024

Related U.S. Application Data
(63) Continuation-in-part of application No. PCT/US22/45298, filed on Sep. 30, 2022.
(60) Provisional application No. 63/251,100, filed on Oct. 1, 2021.
(60) Provisional application No. 63/270,657, filed on Oct. 22, 2021.

(51) Int. Cl. F17C 5/00; F17C 5/06

(52) U.S. Cl. CPC F17C 5/007; F17C 5/06; F17C 2221/012; F17C 2250/032; F17C 2250/043; F17C 2250/0439; F17C 2250/0473; F17C 2265/065; F17C 2270/0139

(57) ABSTRACT

A method of filling a tank with gaseous fuel includes: delivering a gas from a filling station to the tank; communicating a gas temperature measurement and a gas pressure measurement from the tank to the filling station; and based on the gas temperature and gas pressure measurements, modulating a pressure ramp rate of the gas being delivered.

### BACKGROUND OF THE INVENTION

This invention relates generally to gaseous fuel handling and more particularly to methods for fueling hydrogen vehicles.

Although there are proprietary hydrogen fueling protocols utilized for various applications, public access hydrogen stations around the world utilize the fueling protocols defined in SAE J2601, as it is currently the only standardized prescriptive fueling protocol that exists. SAE J2601 defines two fueling protocols: one called the table-based protocol which is based on an average pressure ramp rate determined through lookup tables; and another called the MC Formula protocol which uses equations to dynamically calculate the pressure ramp rate in real time throughout the fill. A fundamental principle of the SAE J2601 fueling protocols is that these protocols do not utilize any information or data communicated from the vehicle to the dispenser for safety critical control functions. This means that although the pressure and temperature of the hydrogen in the on-board compressed hydrogen storage system (CHSS) can be communicated from the vehicle to the dispenser, these data do not influence the pressure ramp rate and thus the fueling time of the fill.

By not utilizing vehicle data for safety critical control functions, the fueling protocols in SAE J2601 are very conservative. These protocols calculate an appropriate pressure ramp rate based on a set of worst-case assumptions for various parameters that affect the temperature development in the CHSS containers. Examples of these worst-case assumptions are the container construction (assumed to be a Type IV container with polymer liner), the container size (assumptions are made regarding the length and diameter of the containers), the initial soak temperature of the container and hydrogen gas (assumed to be at a temperature warmer than ambient), and the initial pressure in the CHSS (assumed to be at a minimum initial pressure). These conditions are chosen because they are at the extremes of what is possible, and therefore, under these conditions cause the hydrogen gas to heat up the most possible. These conditions are generally referred to in SAE J2601 as “hot case” conditions.

The conservative approach utilized in the SAE J2601 fueling protocols was appropriate for the first industry standard as it ensures that the fueling protocols are safe under all conditions, and it minimizes the functional safety requirements for data communications on the vehicle. However, SAE J2601 has been utilized by industry for over 7 years now, and one of the flaws of this conservative approach is that there is an excessive amount of embedded gas temperature margin. This means that the ending gas temperature in the CHSS is significantly lower than the maximum allowed gas temperature for most fills. See FIG. 1 which illustrates the end of fill gas temperature from over 35,000 fills at hydrogen stations utilizing the SAE J2601 MC Formula protocol. The maximum allowable gas temperature is 85° C., yet the maximum gas temperature recorded was 78.9° C. 99.8% of the fills have an ending gas temperature below 75° C., and 90% of fills have an ending gas temperature below 70° C. This embedded margin indicates that the hydrogen dispensed to the vehicle is being pre-cooled to colder temperatures than is necessary, and/or that fueling times are slower than they need to be. Pre-cooling to colder temperatures than is necessary causes station costs to be higher than necessary, and slower fueling times inconvenience the customer while also restricting the number of fueling events that can be achieved by the station within a given timeframe. This simply means that the current SAE J2601 fueling protocols have significant embedded inefficiencies and are not as optimized as they could be.

Although there are probably some additional improvements that can be made to the SAE J2601 fueling protocols without changing the fundamental principle of not utilizing any vehicle information or data for safety critical control functions, the improvements will likely not be of a magnitude sufficient to justify the added complexity to the fueling protocols. In fact, the complexity of the SAE J2601 fueling protocols is another detriment to their use. The current SAE J2601 standard is 293 pages long—one of the longest, if not the longest SAE standard documents in existence. Making an already complex fueling protocol even more complex for small incremental improvements does not make a lot of sense.

Finally, there is a need for new fueling protocols that are appropriate for heavy duty vehicle fueling. These heavy-duty vehicles have significantly larger CHSS and require substantially higher flow rates than what can be facilitated with the current SAE J2601 fueling protocols. The approach utilized in SAE J2601 whereby worst-case assumptions are made regarding the various parameters that affect the temperature development in the CHSS containers, is not practical for these vehicles. The primary reason this approach is not practical is that the size, geometry, and number of containers in the CHSS is much more difficult to bound—there is an almost infinite variety of CHSS designs that could be utilized, so defining a worst case CHSS is very challenging and constraining. Another issue with heavy duty vehicle fueling that is different from light duty vehicle fueling is that the pressure drop from the dispenser pressure measurement location (typically just upstream of the breakaway fitting) and the vehicle CHSS can be substantially higher. Because the pressure ramp rate is controlled based on the pressure measurement at the dispenser, this creates challenges with achieving an acceptable ending state of charge in the CHSS.

What is needed to both increase the efficiency, and thus fueling performance of hydrogen fueling protocols while also reducing their complexity is a new approach based on a new principle whereby vehicle information and data is utilized for safety critical control functions. This approach can be used to improve the fueling performance of light duty vehicles and is especially pertinent to heavy duty vehicle fueling for the reasons mentioned previously. The fueling methods described herein take this approach, although one of the approaches (SOC Throttle) could still be used for fueling protocols utilizing the SAE J2601 principle, since the control function is not safety critical.

### BRIEF SUMMARY OF THE INVENTION

According to one aspect of the technology described herein, a method of filling a tank with gaseous fuel includes: delivering a gas from a filling station to the tank; while delivering the gas: communicating a gas temperature measurement and a gas pressure measurement from the tank to the filling station; based on the gas temperature measurement, computing a time remaining (tremain_Tgas) for a temperature of the gas in the tank to reach a predetermined target temperature; based on the gas temperature and gas pressure measurements, computing a time remaining (tremain_SOC) for a state of charge of the gas in the tank to reach a predetermined target state of charge; determining a difference between (tremain_Tgas) and (tremain_SOC); and modulating a pressure ramp rate of the gas being delivered so as to reduce the difference between (tremain_Tgas) and (tremain_SOC).

According to another aspect of the technology described herein, a method of filling a tank with gaseous fuel includes: delivering a gas from a filling station to the tank, at a ramp pressure; communicating a gas temperature measurement and a gas pressure measurement from the tank to the filling station; increasing the ramp pressure at a pressure ramp rate (PRR_calculated) which is calculated using a preselected fueling protocol (PRR_calculated), until the ramp pressure exceeds a threshold value (P_threshold); once the ramp pressure exceeds P_threshold: based on the gas temperature and gas pressure measurements, computing a state of charge (SOC) based on density using an equation of state; computing a rate of change of SOC (SOCRR) over a lookback period (t_lookback), and based on SOCRR, computing a time remaining (tremain_SOC) for a state of charge of the gas in the tank to reach a predetermined target state of charge; computing a new pressure ramp rate PRR_SOC; comparing PRR_SOC to (PRR_calculated); and in response to PRR_SOC being lower than PRR_calcuated, setting the pressure ramp rate to PRR_SOC.

According to another aspect of the technology described herein, a method of filling a tank with gaseous fuel includes: delivering a gas from a filling station to the tank, at a ramp pressure; communicating a gas temperature measurement and a gas pressure measurement MP from the tank to the filling station; increasing the ramp pressure at a pressure ramp rate (PRR_calculated) which is calculated using a preselected fueling protocol (PRR_calculated), until the ramp pressure exceeds a threshold value (P_threshold); once the ramp pressure exceeds P_threshold: computing a rate of change of MP (PRRMP) over a lookback period (t_lookback), and based on PRRMP, computing a time remaining (tᵣₑₘₐᵢₙ) for a pressure of the gas in the tank to reach a predetermined pressure (Ptarget); computing a new pressure ramp rate PRRtaper; and setting the pressure ramp rate to the lower of: PRRtaper, the PRR calculated by the fueling protocol being utilized (PRRcalculated), and a maximum pressure ramp rate PRRMAX calculated by the fueling protocol being utilized.

According to another aspect of the technology described herein, a method of filling a tank with gaseous fuel includes: delivering a gas from a filling station to the tank, at a ramp pressure: communicating a gas temperature measurement and a gas pressure measurement from the tank to the filling station; increasing the ramp pressure at a pressure ramp rate (PRR_calculated) calculated using a predetermined fueling protocol); once the ramp pressure exceeds P_threshold: based on the gas temperature and gas pressure measurements, computing a state of charge (SOC) based on density using an equation of state; computing a rate of change of SOC (SOCRR) over a lookback period (t_lookback), and based on SOCRR, computing a time remaining (tremain_SOC) for a state of charge of the gas in the tank to reach a predetermined target state of charge; computing a new pressure ramp rate PRR_SOC based on tremain_SOC; comparing PRR_SOC to PRR_calculated; and in response to PRR_SOC being lower than PRR_calcuated, setting the pressure ramp rate to PRR_SOC.

According to another aspect of the technology described herein, a method of filling a tank with gaseous fuel includes: delivering a gas from a filling station to the tank, at a ramp pressure: communicating a gas temperature measurement (Tgas_high) and a gas pressure measurement from the tank to the filling station; setting values for a set of parameters (a, b, Tgas_max and Tgas_target); increasing the ramp pressure at a pressure ramp rate (PRR_calculated) calculated using a predetermined fueling protocol; computing a pressure drop (DeltaP) as the difference between the ramp pressure (P_ramp) and the tank pressure; computing a maximum value of the pressure drop (DeltaP_max); computing a temperature threshold value T_threshold as (DeltaP_max) subtracted from Tgas_target; in response to the gas temperature being greater than T_threshold: computing a pressure ramp rate (PRR_threshold); computing an adaptable denominator (AD) as the maximum value of either “b” or the product of “a” and DeltaP; computing a new pressure ramp rate (PRR_throttle) as the maximum value of either zero or the product: PRR_threshold times (Tgas_target minus Tgas_high) divided by AD; comparing PRR_throttle to PRR_calculated; and in response to PRR_throttle being lower than PRR_calculated, setting the pressure ramp rate to PRR_throttle.

According to another aspect of the technology described herein, a method of filling a tank with gaseous fuel includes: delivering a gas from a filling station to the tank, at a ramp pressure; setting values for a set of parameters (a, b_min, TMAL, Tgas_max, Tgas_target, Tgas_smooth_threshold, Tgas_diff_factor, and Tgas_diff_multiplier); communicating a gas temperature measurement (Tgas_high) and a gas pressure measurement from the tank to the filling station; increasing the ramp pressure at a pressure ramp rate (PRR_calculated) calculated using a predetermined fueling protocol; computing a pressure drop (DeltaP) as the difference between the ramp pressure and the tank pressure; computing a maximum value of the pressure drop (DeltaP_max); computing a triple moving average of Tgas_high with each moving average having a length of TMAL, referred to as Tgas_smooth; computing a temperature threshold value T_threshold as DeltaP_max subtracted from Tgas_target; in response to Tgas_smooth being greater than T_threshold: computing a pressure ramp rate (PRR_threshold); in response to Tgas_smooth being greater than Tgas_smooth_threshold: computing Tgas_diff as the difference between Tgas_high and Tgas_smooth; computing a maximum value of Tgas_diff, defined as Tgas_diff_max; computing Tgas_offset as the product of Tgas_diff_factor and Tgas_diff_max; computing Tgas_target as Tgas_max minus Tgas_offset; computing parameter b as the maximum value of either b_min or the product of Tgas_offset_multiplier and Tgas_offset; computing an adaptable denominator AD as the maximum value of either parameter b or the product of: parameter a and DeltaP; computing a new pressure ramp rate (PRR_throttle) as the maximum value of either zero or the product of PRR_threshold multiplied by (Tgas_target minus Tgas_smooth) divided by AD; comparing PRR_throttle to PRR_calculated; and in response to PRR_throttle being less than PRR_calculated, setting the pressure ramp rate to PRR_throttle.

### BRIEF DESCRIPTION OF THE DRAWINGS

The invention may be best understood by reference to the following description taken in conjunction with the accompanying drawing figures, in which:

FIG. 1 is end of fill gas temperature histogram from over 35,000 MC formula fills;

FIG. 2 is a flow chart for a fueling control process according to a first aspect of the present invention;

FIG. 3 is an example temperature, pressure, and SOC vs. time graph for an application of the process shown in FIG. 2;

FIGS. 4A and 4B contain a flow chart for a fueling control process according to a second aspect of the present invention;

FIG. 5 is an example pressure and SOC vs. time graph for an application of the process shown in FIGS. 4A and 4B;

FIG. 6 is a flow chart for a fueling control process according to a third aspect of the present invention;

FIG. 7 is an example pressure and SOC vs. time graph for an application of the process shown in FIG. 6;

FIG. 8A is a graph comparing a moving average smoothed gas temperature to an actual gas temperature, over time;

FIG. 8B is an enlarged view of a portion of the graph of FIG. 8A;

FIG. 9 is a graph showing various temperature and pressure parameters vs. time;

FIG. 10 is a graph showing a gas temperature vs. a smoothed gas temperature parameter;

FIG. 11 is a graph showing a gas temperature and a smoothed gas temperature vs. time;

FIG. 12 is a graph showing self-adjusting parameters;

FIGS. 13A and 13B contain a flow chart for a fueling control process according to an aspect of the present invention;

FIG. 14 is an example temperature vs. time graph for an application of the process shown in FIGS. 13A and 13B;

FIGS. 15A and 15B contain a flow chart for a fueling control process according to an aspect of the present invention;

FIG. 16 is a schematic diagram of the elements required for implementation of the fueling methods described herein; and

FIG. 17 is an example pressure vs. time graph for a variant of the process shown in FIG. 6.

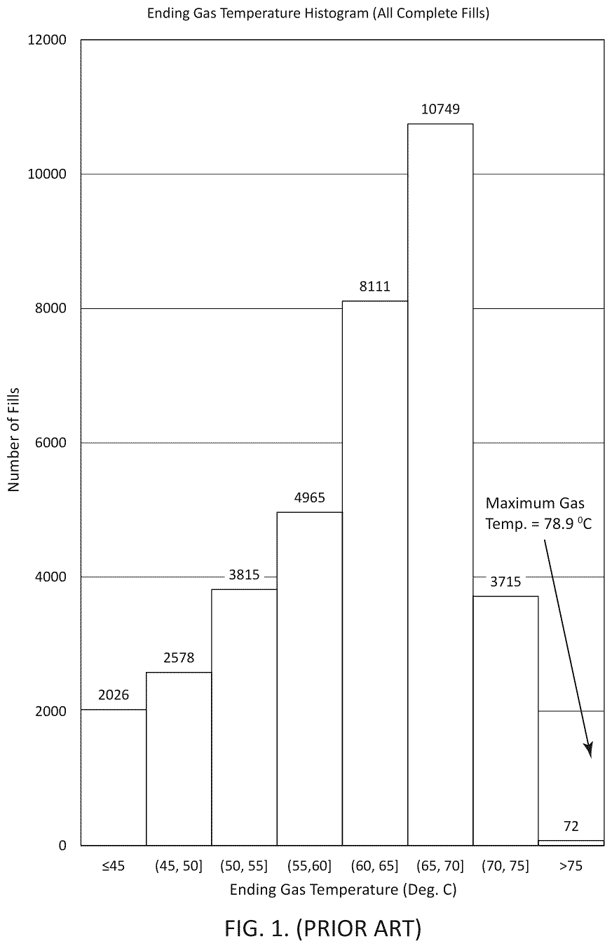

### DETAILED DESCRIPTION OF THE INVENTION

### Fueling Methods

One fueling method is referred to as “Lookback T_{gas} Throttle”. Another is referred to as “SOC Throttle.” Lookback T_{gas} Throttle utilizes the gas temperature and pressure communicated from the vehicle to the dispenser to throttle or reduce the pressure ramp rate so that the gas temperature approaches but does not exceed the maximum allowed gas temperature of the CHSS containers. SOC Throttle utilizes the gas temperature and gas pressure communicated from the vehicle to the dispenser to first calculate an SOC within the CHSS and then to throttle or reduce the pressure ramp rate so that the desired target SOC can be achieved at the end of the fill without exceeding the operating process limit for the dispenser pressure.

Lookback T_{gas} Throttle: The Lookback T_{gas} Throttle fueling method is designed to trigger when the gas temperature within the CHSS container(s) reaches a threshold value. Once this threshold temperature is exceeded, the pressure ramp rate is regulated in response to the rising gas temperature. This feature has two primary advantages. The first advantage is that it prevents the gas temperature from exceeding the maximum allowable temperature, which is a function of the CHSS qualification standard. The standards typically utilized are SAE J2579, ISO 19881, and UN GTR 13 (a global technical regulation), which impose a maximum allowable gas temperature of 85° C. In the future, these standards may be modified to allow for a higher maximum allowable gas temperature and this approach can accommodate whatever maximum gas temperature the CHSS is designed for. The second advantage of this feature of the Lookback T_{gas} Throttle fueling method is that it allows the gas temperature to approach the maximum allowable temperature, which increases the ΔT between the gas temperature and container wall temperature, increasing the heat flux and facilitating faster fueling. In simple thermodynamic terms, the gas temperature development within the container is a function of the enthalpy of gas entering the container and heat flux from the gas to the container walls. Reducing the enthalpy or increasing the heat flux can both facilitate faster fueling. Because the primary way to reduce the enthalpy is to dispense the hydrogen to the vehicle CHSS at a colder temperature, reducing the enthalpy is not the preferred approach. Therefore, maximizing the heat flux is the best way to reduce fueling times for a given fuel delivery temperature.

The Lookback T_{gas} Throttle fueling method can be implemented with fueling protocols using existing pressure ramp rate control strategies, for example the table-based protocol and the MC Formula protocol in SAE J2601, or any other pressure ramp rate based control. These control strategies are utilized when the gas temperature in the CHSS container(s) is below the temperature threshold value, and once the gas temperature exceeds this value, the T_{gas} Throttle pressure ramp rate equations are then applied.

The pressure ramp rates utilized prior to the temperature threshold being breached should be faster than those utilized in SAE J2601, as those pressure ramp rates are already limited to ensure the gas temperature doesn't exceed the maximum allowable temperature, even under worst case conditions. Therefore, with the Lookback T_{gas} Throttle approach applied, more aggressive pressure ramp rates can be utilized, which has the benefit of faster fueling under all conditions, especially under conditions where the parameters influencing the temperature development in the CHSS containers are not at their extremes. For example, if the initial gas temperature and wall temperature of the containers in the CHSS are colder than the ambient temperature, the gas temperature developed during the fill will be lower. This will result in less pressure ramp rate throttling, and because the initial pressure ramp rates are more aggressive to begin with, fueling times will be shorter.

For CHSS utilizing multiple containers, the Lookback T_{gas} Throttle fueling method utilizes the container with the highest gas temperature reading as the control input. This is referred to as T_{gas_high}. The T_{gas_high} parameter is communicated to the dispenser via a communication protocol. This can be the IRDA-based communication protocol described in SAE J2799, or it can be another communications protocol implemented via a different transmission mechanism such as wired communications or radio-based wireless communications such as 5G, Bluetooth, or Wi-Fi. Because the pressure ramp rate is calculated based on T_{gas_high}, both the measurement and transmission of this data to the dispenser should be highly reliable based on a comprehensive functional safety assessment resulting in the appropriate safety integrity levels applied.

An example implementation of the Lookback T_{gas} Throttle fueling method is as follows:

### Definitions

T_{gas_high}: the highest bulk average gas temperature in the CHSS (communicated from the vehicle to the station)

T_{gas_max}: the maximum allowable gas temperature in the CHSS (communicated from the vehicle to the station)

T_{gas_target}: the practical allowable gas temperature in the CHSS (accounting for needed tolerances)

P_{gas}: the gas pressure in the CHSS (communicated from the vehicle to the station)

T_{threshold}: The threshold temperature above which the T_{gas} Throttle PRR equations are applied (can be a function of the maximum pressure drop between the dispenser pressure (or ramp pressure) and CHSS pressure, e.g. T_{gas_target}−aΔPₘₐₓ, where “a” is a tuning parameter, or some other function)

PRR_{threshold}: The pressure ramp rate at the time that T_{gas_high}=T_{threshold}

Pᵣₐₘₚ: The ramp pressure for each time step. This is the pressure the dispenser is targeting and is a function of the ramp pressure one time step ago and the pressure ramp rate. Pᵣₐₘₚ₍ᵢ₎=Pᵣₐₘₚ₍ᵢ₋₁₎+PRR₍ᵢ₎

t_{lookback}: A lookback time period in seconds. It can be a fixed value or a function of the pressure ramp rate prior to the threshold temperature being exceeded or based on some other criteria

i: Represents the current time step, i−t_{lookback} is the time step of the lookback period (i.e. t_{lookback} seconds ago). i+1 represents the next time step. A timestep is typically one second.

TGASRR_{lookback}: The rate of change of T_{gas_high} over the lookback period. This can be calculated based on subtracting the current T_{gas_high}(i) from the T_{gas_high(i-t_lookback)} t_{lookback} seconds ago and dividing by t_{lookback}. Alternatively, TGASRR_{lookback} can be calculated based on the slope of a linear regression fit of T_{gas_high} over the t_{lookback} period.

t_{remain_Tgas}: The time remaining for T_{gas_high} to reach T_{gas_target} based on TGASRR_{lookback}

The state of charge (SOC) in the CHSS is based on 100 times the calculated density divided by the density at nominal conditions (i.e. nominal working pressure (NWP) and 15° C. temperature). The density is calculated based on an equation of state and is a function of P_{gas} and T_{gas_low} (these parameters are communicated from the vehicle to the station)

SOC_{target}: The desired end of fill SOC (e.g. 97%)

SOCRR_{lookback}: The rate of change of SOC over the lookback period. This can be calculated based on subtracting the current SOC₍ᵢ₎ from the SOC_{(i-t_lookback)} t_{lookback} seconds ago and dividing by t_{lookback}. Alternatively, SOCRR_{lookback} can be calculated based on the slope of a linear regression fit of SOC over the t_{lookback} period.

t_{remain_SOC}: The time remaining for SOC to reach SOC_{target} based on SOCRR_{lookback}

PRR: The pressure ramp rate for each time step throughout the fill. This pressure ramp rate is used to calculate Pᵣₐₘₚ for each time step.

PRR_{calculated}: The pressure ramp rate calculated by the fueling protocol, for example, PRR_{MC} using the MC Formula fueling protocol algorithm. PRR_{calculated} is calculated throughout the fill and is used to control the fill prior to the point in the fill when T_{gas_high} exceeds T_{threshold}

PRRₜₕᵣₒₜₜₗₑ: The pressure ramp rate calculated by the Lookback Tgas Throttle algorithm.

ΔPRR: The change in PRR for each timestep when throttling down or up

PRRₘᵢₙ: The minimum PRR (can be determined as a function of PRR_{threshold}, e.g. PRR_{threshold}/5, or some other function)

$$Equations :$$

$$IF {T}_{gas \_ high} \geq {T}_{threshold} THEN \qquad ( Eq 1.1 )$$

$${PRR}_{threshold} = PRR at the timestep when {T}_{gas \_ high} first exceeded {T}_{threshold} \qquad ( Eq 1.2 )$$

$$Calculate Lookback Period ( rounded to nearest integer value ) \text{} : {t}_{lookback} = f ( {PRR}_{threshold} , Other ) \qquad ( Eq 1.3 )$$

$$Calculate a lookback {T}_{gas \_ high} ramp rate : {TGASRR}_{lockback ( i )} = \frac{( {T}_{gas \_ high ( i )} - {T}_{gas \_ high ( i - {t}_{lookback} )} )}{{t}_{lookback}} \qquad ( Eq 1.4 )$$

$$( Note : If {TGASRR}_{lookback} is a negative value , then set {TGASRR}_{lookback} = 1. \times {10}^{- 10} )$$

$$Calculate lookback SOC ramp rate : {SOCRR}_{lookback ( i )} = \frac{( {SOC}_{( i )} - {SOC}_{( i - {t}_{lookback} )} )}{{t}_{lookback}} \qquad ( Eq 1.5 )$$

$$Calculate time remaining based on {TGASRR}_{lookback} : {t}_{remain \_ Tgas ( i )} = \frac{( {T}_{gas \_ target} - {T}_{gas \_ high ( i )} )}{{TGASRR}_{lookback}} \qquad ( Eq 1.6 )$$

$$Calculate time remaining based on lookback SOC ramp rate : {t}_{remainSOC ( i )} = \frac{( {SOC}_{target} - {SOC}_{( i )} )}{{SOCRR}_{lookback} ( i )} \qquad ( Eq 1.7 )$$

$$\begin{matrix}If {1}^{st} time through the loop , then {PRR}_{throttle ( i - 1 )} = {PRR}_{( i - 1 )} & ( Eq 1.8 )\end{matrix}$$

$$IF {t}_{remain \_ Tgas ( i )} < {t}_{remain \_ SOC ( i )}$$

$$THEN {PRR}_{throttle ( i )} = {PRR}_{throttle ( i - 1 )} - Δ PRR$$

$$ELSE {PRR}_{throttle ( i )} = {PRR}_{throotle ( i - 1 )} + Δ PRR$$

$$IF {PRR}_{throotle ( i )} < {PRR}_{m i n} , Then {PRR}_{throttle ( i )} = {PRR}_{m i n}$$

$$IF {PRR}_{throttle ( i )} > {PRR}_{calculated ( i )} , Then {PRR}_{throttle ( i )} = {PRR}_{calculated ( i )}$$

$$If {t}_{remain \_ Tgas ( i )} < 0 , THEN {PRR}_{throttle ( i )} = {PRR}_{m i n}$$

$${PRR}_{( i )} = {PRR}_{throttle ( i )}$$

$$Calculate the pressure ramp for the next time step i + 1 : {P}_{ramp ( i + 1 )} = {P}_{ramp ( i )} + {PRR}_{( i )} \qquad ( Eq 1.9 )$$

$$i = i + 1 and Loop Back to Eq 1.4$$

### ELSE

$$Calculate PRR according to the fueling protocol being utilized , e . g . {PRR}_{( i )} = {PRR}_{calculated ( i )} \qquad ( Eq 1.1 )$$

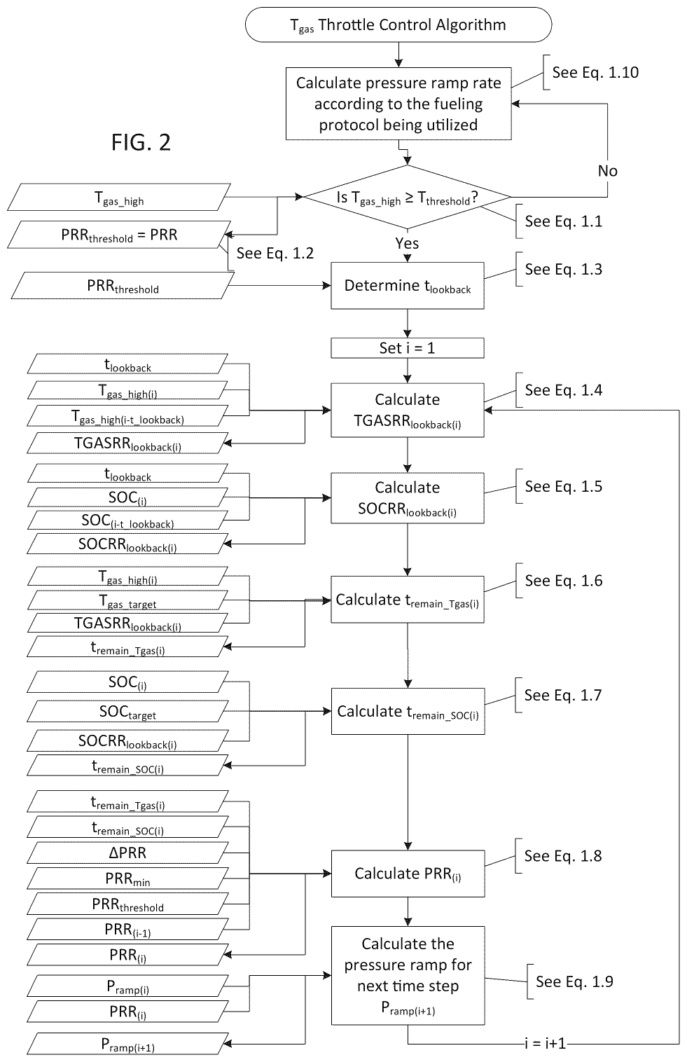

Flow Chart: FIG. 2 is a flow chart showing the implementation of Eq. 1.1 through 1.10 set forth above. It is noted that the algorithm in the flow chart may have a calculation frequency suitable for the particular application. One example calculation frequency is 1 Hz.

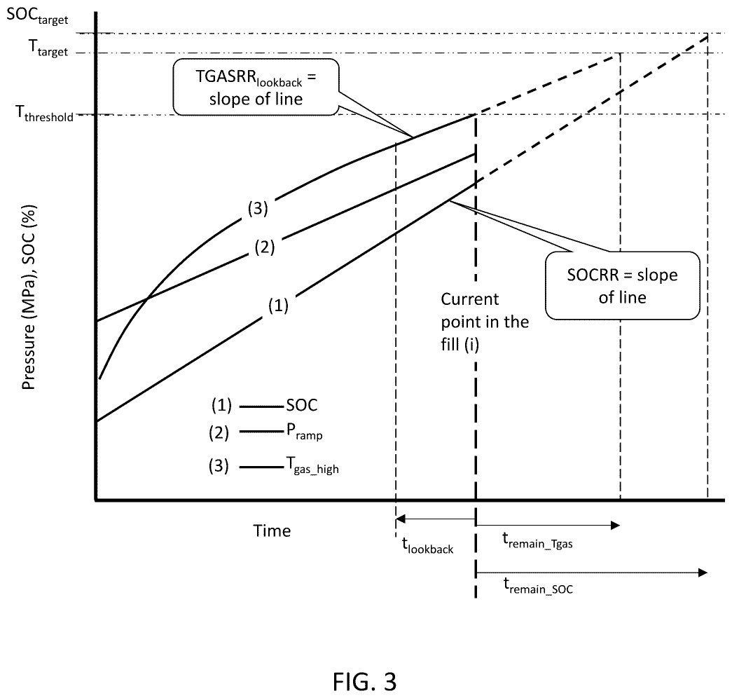

FIG. 3 illustrates the operation of the Lookback T_{gas} Throttle Method. The illustration shows the current point of the fill as time i and fill history up to this point is represented by solid lines. The dashed portion of the line labeled (3), is a projection of T_{gas_high} based on the rate of change, represented by TGASRR_{lookback}. The dashed portion of the line labeled (1), is a projection of the SOC based on the rate of change, represented by SOCRR_{lookback}. As can be seen, based on these projections, T_{gas_high} reaches T_{gas_target} at a time sooner than when the SOC reaches SOC_{target}. This time difference is represented by comparing t_{remain_Tgas} to t_{remain_SOC}. Because t_{remain_Tgas} is shorter than t_{remain_SOC}, the pressure ramp rate needs to be reduced. As long as t_{remain_Tgas} is shorter than t_{remain_SOC}, the pressure ramp rate is reduced by ΔPRR each time step until it reaches PRRₘᵢₙ. When t_{remain_Tgas} is longer than t_{remain_SOC}, the pressure ramp rate is increased by ΔPRR each time step until it reaches PRR_{calculate}. The PRRₜₕᵣₒₜₜₗₑ can never exceed PRR_{calculated}. This process essentially regulates the pressure ramp rate so that T_{gas_high} reaches T_{gas_target} at the same time as SOC reaches SOC_{target}.

### SOC Throttle:

SOC throttle is a fueling method intended to reduce the fueling time for fills that are constrained by the pressure drop between the dispenser pressure and the CHSS pressure. This is especially important for fueling of heavy-duty vehicles where the mass flow rates can be substantially higher than with light duty vehicle fueling. The SOC Throttle algorithm is intended to be used in conjunction with fueling protocols that use pressure ramp rate control strategies, for example the table-based protocol and the MC Formula protocol in SAE J2601, or any other pressure ramp rate based control. The control strategies regulate the rate of change of the ramp pressure, which is the pressure the dispenser targets for its measured pressure at each point in time (or time step) during the fill. This control strategy can increase or decrease the pressure ramp rate based on current conditions, at least for approaches like MC Formula that dynamically calculate the pressure ramp rate throughout the fill. Typically, the pressure ramp rate used in these control strategies is derived by ensuring the following four conditions are satisfied: a) the dispenser pressure does not exceed the maximum allowable pressure; b) the gas temperature within the CHSS does not exceed the maximum allowable temperature; c) the mass flow rate does not exceed the maximum value; and d) the SOC within the CHSS reaches an acceptable level, typically 95 to 100%. The problem with this approach is that often times, the derived pressure ramp rate is constrained by the requirement to meet the SOC target without the dispenser pressure exceeding the maximum dispenser pressure. The pressure ramp rate must be constrained such that pressure drop between the dispenser pressure and CHSS pressure is low enough to achieve the SOC target in the CHSS while at the same time not allowing the dispenser pressure to exceed the maximum value. This typically occurs under fueling conditions where the gas temperature in the CHSS does not approach the maximum allowable temperature, for example, under colder ambient temperatures or colder fuel delivery temperatures. If the pressure drop between the dispenser pressure and the CHSS pressure could be reduced, it would allow for faster fueling. However, the pressure drop is typically a function of the flow coefficients (or flow resistance) of the components utilized (i.e., the breakaway fitting, hose, nozzle, receptacle, and the tubing/manifolds/valves that make up the fuel delivery system of the CHSS). One way to reduce the pressure drop at the end of the fill is to fuel at a faster pressure ramp rate earlier in the fill so that more hydrogen is dispensed, allowing for the pressure ramp rate to be reduced towards the end of the fill. The SOC Throttle fueling methods implements this approach.

The SOC Throttle operates by utilizing both the CHSS gas temperature and CHSS gas pressure communicated from the vehicle to the dispenser to calculate an SOC within the CHSS for each timestep throughout the fill, and then to throttle or reduce the pressure ramp rate (only if needed) so that the desired target SOC can be achieved at the end of the fill without exceeding the operating process limit for the dispenser pressure. The SOC is directly a function of the gas density. Using an equation of state, the gas density can be calculated from the gas pressure and gas temperature within the CHSS. The SOC is expressed as a percentage of the measured gas density in the CHSS to the gas density at reference conditions, typically at the nominal working pressure of the storage vessel and a temperature of 15° C. As an example, the density of hydrogen at 100% SOC for a 70 MPa storage vessel is 40.2 g/l.

The SOC Throttle fueling method allows the derivation of the average pressure ramp rate or the parameters used in calculating a dynamic pressure ramp rate (for example, the t_{final} equation and associated a, b, c, d parameters used in SAE J2601 MC Formula) to be much faster than otherwise would be the case. This is made possible by eliminating one of the constraints in the derivation of the average pressure ramp rate or the parameters for a dynamic pressure ramp rate. The constraint that is eliminated is the requirement that the dispenser pressure not exceed the maximum allowable pressure. The remaining three constraints are that the gas temperature within the CHSS does not exceed the maximum allowable temperature, the flow rate does not exceed the maximum value, and the SOC within the CHSS reaches an acceptable level (typically 95 to 100%). For conditions where the CHSS gas temperature does not exceed the maximum allowable temperature, the peak flow rate becomes the constraining factor. Without the SOC Throttle fueling method applied, however, this pressure ramp rate would be much too fast at the end of the fill, causing a very large pressure drop between the dispenser pressure and the CHSS pressure, resulting in poor SOC. The SOC Throttle approach throttles back or reduces the pressure ramp rate once a pressure threshold value has been exceeded, only when required, and only sufficiently that the SOC target can be achieved without the dispenser pressure exceeding its maximum allowable pressure.

There are two implementations of the SOC Throttle approach. These two implementations have the same objective, but differ slightly in their implementation.

Definitions (Common to both example implementations):

T_{gas_low}: the lowest bulk average gas temperature in the CHSS (communicated from the vehicle to the station)

P_{gas}: the gas pressure in the CHSS (communicated from the vehicle to the station)

Pᵣₐₘₚ: The ramp pressure for each time step. This is the pressure the dispenser is targeting and is a function of the ramp pressure one time step ago and the pressure ramp rate. Pᵣₐₘₚ(i)=Pᵣₐₘₚ₍ᵢ₋₁₎+PRR₍ᵢ₎

P_{ramp_target}: The end of fill maximum ramp pressure, typically 1.25×NWP, although it can be a lower value than this to provide necessary margin.

AP: The difference between the ramp pressure Pᵣₐₘₚ₍ᵢ₎ and the pressure in the CHSS P_{CHSS(i)}. OR The difference between the station pressure Pₛₜₐₜᵢₒₙ₍ᵢ₎ and the pressure in the CHSS P_{CHSS(i)}.

ΔPₘₐₓ: The maximum value of AP measured during the fill.

P_{threshold}: A threshold pressure above which the SOC Throttle approach is applied. P_{threshold} can be a fixed value or a function. Examples of functions are shown below:

$${P}_{threshold} = Y \times NWP where Y = 0.8 , 0.9 , 1 , 1.1 , etc . \\ OR \\ {P}_{threshold} = {P}_{ramp \_ target} - Δ P \\ OR \\ {P}_{threshold} = {P}_{ramp \_ target} - Δ {P}_{ma x} \\ OR \\ {P}_{threshold} = {P}_{ramp \_ target} ( \frac{{SOC}_{target} - ( {P}_{ramp ( \% )} - SOC )}{100} ) \\ Where {P}_{ramp ( \% )} = 100 ( \frac{{P}_{ramp}}{{P}_{ramp \_ target}} ) and {SOC}_{target} is the desired end of fill SOC$$

PRR_{calculated}: A calculated pressure ramp rate based on the fueling protocol utilized. This could be an average pressure ramp rate from a lookup table or a dynamically calculated pressure ramp rate based on a control parameter such as t_{final} in the MC Formula protocol (i.e. PRR_{MC})

t_{lookback}: A lookback time period in seconds. It can be a fixed value, a function of the pressure ramp rate, or be based on some other criteria such as a percentage of t_{final}

i: Represents the current time step. i−t_{lookback} is the time step of the lookback period (i.e. t_{lookback} seconds ago). i+1 represents the next time step. A timestep is typically one second.

SOC: The state of charge in the CHSS based on 100 times the calculated density divided by the density at ₙₒₘᵢₙₐₗ conditions (i.e. nominal working pressure and 15° C. temperature). The density is calculated based on an equation of state and is a function of P_{gas} and T_{gas_low} (these parameters are communicated from the vehicle to the station)

SOC_{target}: The desired end of fill SOC (e.g. 97%)

SOCRR_{lookback}: The rate of change of SOC over the lookback period

t_{remain_SOC}: The time remaining for SOC to reach SOC_{target} based on SOCRR_{lookback}

PRR_{SOC}: A pressure ramp rate calculated such that Pᵣₐₘₚ reaches the P_{ramp_target} at the same time that the SOC reaches SOC_{target}

PRR_{lookback}: The rate of change of the ramp pressure Pᵣₐₘₚ over the lookback period

tᵣₑₘₐᵢₙ_PRR: The time remaining for Pᵣₐₘₚ to reach Pᵣₐₘₚ_target based on PRR_{lookback}

Equations for Example Implementation 1:

$$Calculated {PRR}_{calculated ( i )} : {PRR}_{calculated ( i )} = PRR calculated for the next time step according to the PRR control strategy being utilized ( e . g . APRR for table - based method , {PRR}_{MC} based on {t}_{final} for MC Formula method ) \qquad ( Eq 2.1 )$$

$$IF {P}_{ramp ( i )} \geq {P}_{threshold} \qquad ( Eq 2.2 )$$

$$THEN$$

$$Calculate Lookback Period ( rounded to nearest integer value ) : {t}_{lookback} = f ( PRR , {t}_{final} Other ) \qquad ( Eq 2.3 )$$

$$Calculate lookback SOC ramp rate : {S OCRR}_{lookback ( i )} = \frac{( {soc}_{( i )} - {soc}_{( i - {t}_{lookback}} )}{{t}_{lookback}} \qquad ( Eq 2.4 )$$

$$NOTE : IF i < {t}_{lookback} , THEN {SOC}_{( i - tlookback )} = {SOC}_{( i = 0 )}$$

$$Calculate lookback pressure ramp rate : {PRR}_{lookback ( i )} = \frac{( {P}_{ramp ( i )} - {P}_{ramp ( i - {t}_{lookback}} )}{{t}_{lookback}} \qquad ( Eq 2.5 )$$

$$NOTE : IF i < {t}_{lookback} , THEN {Pramp}_{( i - tlookback )} = {Pramp}_{( i = 0 )}$$

$$Calculate time remaining based on lookback SOC ramp rate : {t}_{remainSOC ( i )} = \frac{( {soc}_{target} - {soc}_{( i )} )}{{SOCRR}_{lookback} ( i )} \qquad ( Eq 2.6 )$$

$$Calculate time remaining based on lookback pressure ramp rate : {t}_{remainPRR ( i )} = \frac{{P}_{ramp \_ target} - {P}_{ramp ( i )}}{{PRR}_{lookback} ( i )} \qquad ( Eq 2.7 )$$

$$Calculate {PRR}_{SOC} : {PRR}_{SOC ( i )} = \frac{( {P}_{ramp \_ target} - {P}_{ramp ( i )} )}{{t}_{remainSOC ( i )}} \qquad ( Eq 2.8 )$$

$$IF {t}_{remainPRR ( i )} < {t}_{remainSOC ( i )} \qquad ( Eq 2.9 )$$

$$THEN {PRR}_{( i )} = MINIMUM [ {PRR}_{calculated ( i )} , {PRR}_{SOC ( i )} ] \qquad ( Eq 2.1 )$$

$$ELSE {PRR}_{( i )} = {PRR}_{calculated ( i )} \qquad ( Eq 2.11 )$$

$$END IF$$

$$Calculate the pressure ramp for the next time step i + 1 : {P}_{ramp ( i + 1 )} = {P}_{ramp ( i )} + {PRR}_{( i )} \qquad ( Eq 2.12 )$$

$$i = i + 1 and Loop Back to Eq 2.1$$

$$ELSE$$

$${PRR}_{( i )} = {PRR}_{calculated ( i )} \qquad ( Eq 2.13 )$$

$$Calculate the pressure ramp for the next time step i + 1 : {P}_{ramp ( i + 1 )} = {P}_{ramp ( i )} + {PRR}_{( i )} \qquad ( Eq 2.14 )$$

$$i = i + 1 and Loop Back to Eq 2.1$$

### END IF

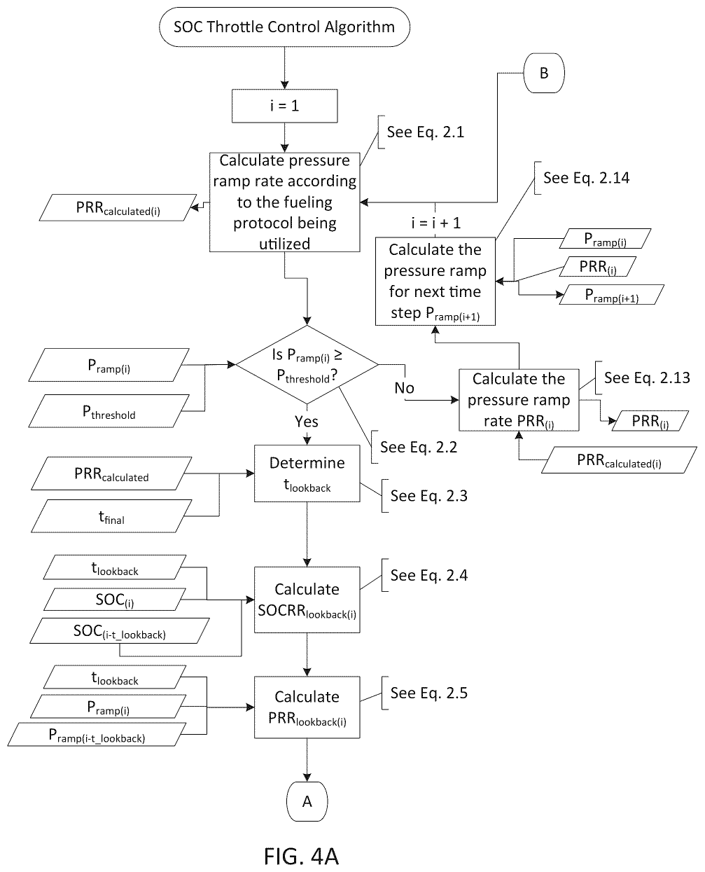

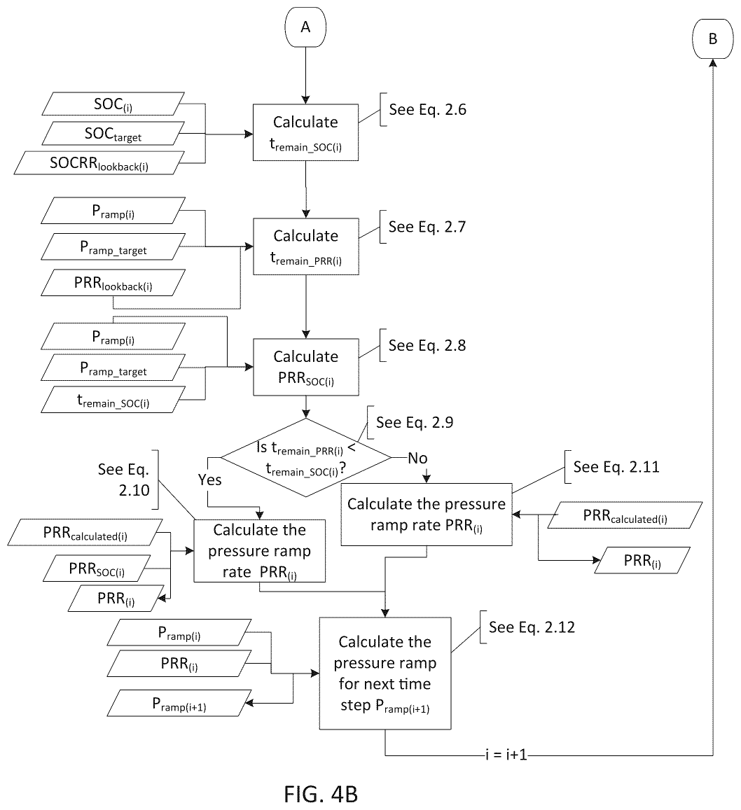

Flow Chart: FIGS. 4A and 4B contain a flow chart showing the implementation of Eq. 2.1 through 2.14 set forth above. It is noted that the algorithm in the flow chart may have a calculation frequency suitable for the particular application. One example calculation frequency is 1 Hz.

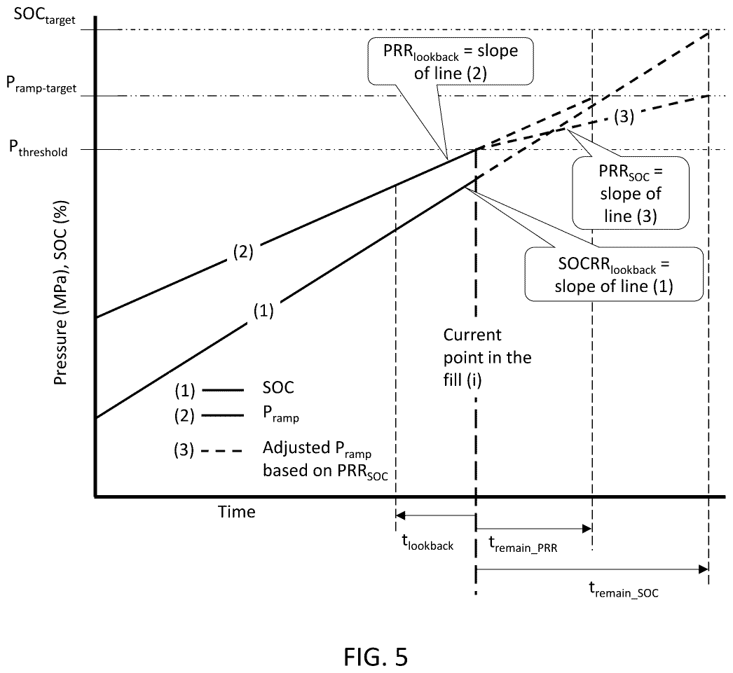

FIG. 5 illustrates the operation of the SOC Throttle fueling method example implementation 1. The illustration shows the current point of the fill as time i and fill history up to this point is represented by solid lines. The dashed portion of the line labeled (2), is a projection of Pᵣₐₘₚ based on the pressure ramp rate calculated over the lookback period, i.e. PRR_{lookback}. The dashed portion of the line labeled (1), is a projection of SOC based on the rate of change, represented by SOCRR_{lookback}. As can be seen, based on these projections, Pᵣₐₘₚ reaches P_{ramp_target} at a time sooner than when SOC reaches SOC_{target}. If the fill continues at this pressure ramp rate, the ending SOC will be below the target SOC which is not desirable. This requires the pressure ramp rate to be reduced such that Pᵣₐₘₚ reaches P_{ramp_target} at the same time that SOC reaches SOC_{target} This is accomplished by calculating a new pressure ramp rate PRR_{SOC} based on t_{remain_SOC}. Finally, PRR_{SOC} is compared to PRR_{calculated} and the slower of the two values is used as the pressure ramp rate PRR for the next time step. This approach allows the target SOC to always be reached in the fastest time possible, while also facilitating a slower pressure ramp rate if the calculated pressure ramp rate dictates that, for example, due to the fuel delivery temperature of the hydrogen warming (causing the enthalpy to increase and requiring an extension of the fill time).

Equations for Example Implementation 2:

$$Calculate {PRR}_{calculated ( i )} : {PRR}_{calculated ( i )} = PRR calculated for the next time step according to the PRR control strategy being utilized ( e . g . APRR for table - based method , {PRR}_{MC} based on {t}_{final} for MC Formula method ) \qquad ( Eq 3.1 )$$

$$IF {P}_{ramp ( i )} \geq {P}_{threshold} \qquad ( Eq 3.2 )$$

$$THEN$$

$$Calculate Lookback Period ( rounded to nearest integer value ) : {t}_{lookback} = f ( PRR , {t}_{final} Other ) \qquad ( Eq 3.3 )$$

$$Calculate lookback SOC ramp rate : {SOCRR}_{lookback ( i )} = \frac{( {soc}_{( i )} - {soc}_{( i - {t}_{lookback}} )}{{t}_{lookback}} \qquad ( Eq 3.4 )$$

$$Note : IF i < {t}_{lookback} , THEN {SOC}_{( i - tlookback )} = {SOC}_{( i = 0 )}$$

$$Calculate time remaining based on lookback SOC ramp rate : {t}_{remainSOC ( i )} = \frac{( {soc}_{target} - {soc}_{( i )} )}{{SOCRR}_{lookback} ( i )} \qquad ( Eq 3.5 )$$

$$Calculate {PRR}_{SOC} : {PRR}_{SOC ( i )} = \frac{( {P}_{ramp \_ target} - {P}_{ramp ( i )} )}{{t}_{remainSOC ( i )}} \qquad ( Eq 3.6 )$$

$${PRR}_{( i )} = MINIMUM [ {PRR}_{calculated ( i )} , {PRR}_{SOC ( i )} ] \qquad ( Eq 3.7 )$$

$$Calculate the pressure ramp for the next time step i + 1 : {P}_{ramp ( i + 1 )} = {P}_{ramp ( i )} + {PRR}_{( i )} \qquad ( Eq 3.8 )$$

$$i = i + 1 and Loop Back to Eq 3.1$$

$$ELSE$$

$${PRR}_{( i )} = {PRR}_{calculated ( i )} \qquad ( Eq 3.9 )$$

$$Calculate the pressure ramp for the next time step i + 1 : {P}_{ramp ( i + 1 )} = {P}_{ramp ( i )} + {PRR}_{( i )} \qquad ( Eq 3.1 )$$

$$i = i + 1 and Loop Back to Eq 3.1$$

### END IF

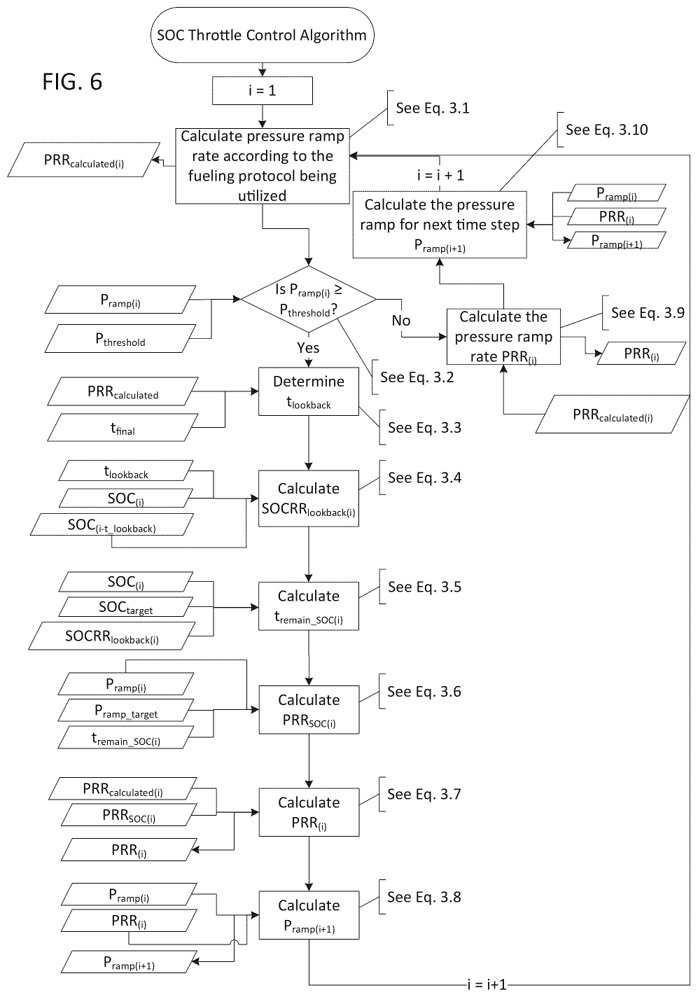

Flow Chart: FIG. 6 is a flow chart showing the implementation of Eq. 3.1 through 3.10 set forth above. It is noted that the algorithm in the flow chart may have a calculation frequency suitable for the particular application. One example calculation frequency is 1 Hz.

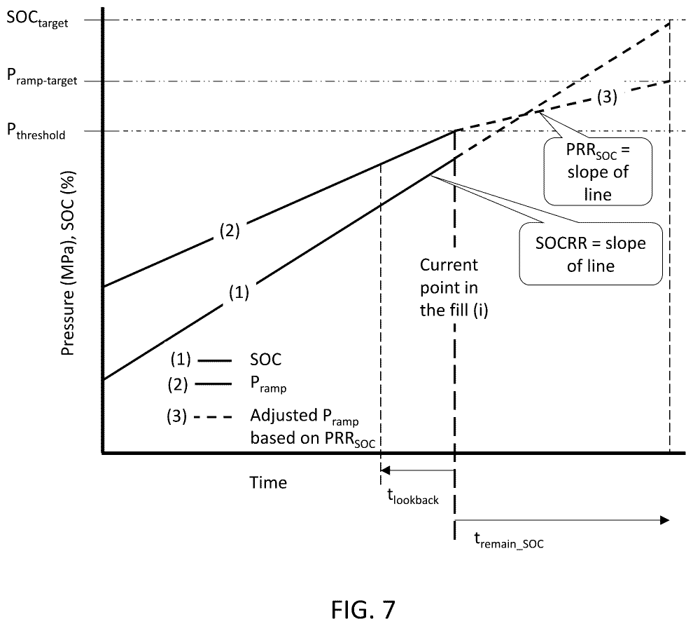

FIG. 7 illustrates the operation of the SOC Throttle fueling method example implementation 2. The illustration shows the current point of the fill as time i and fill history up to this point is represented by solid lines. At this point, Pᵣₐₘₚ has just reached P_{threshold}.

The rate of change in SOC is calculated based on a lookback period t_{lookback}. This value is called SOCRR_{lookback}. From this the time remaining for the SOC to reach its target value can be calculated. This value is t_{remain_SOC}. A pressure ramp rate PRR_{SOC} is calculated based on t_{remain_SOC}, which is the pressure ramp rate at which Pᵣₐₘₚ will reach P_{ramp_target} at the same time that SOC reaches SOC_{target} Finally, PRR_{SOC} is compared to PRR_{calculated} and the slower of the two values is used as the pressure ramp rate PRR for the next time step. This approach allows the target SOC to always be reached in the fastest time possible, while also facilitating a slower pressure ramp rate if the calculated pressure ramp rate dictates that, for example, due to the fuel delivery temperature of the hydrogen warming (causing the enthalpy to increase and requiring an extension of the fill time).

A variation of the SOC throttle fueling method is referred to as a “PRR Taper method”. This is similar to the SOC throttle method described above in that the same calculations are used, but they are based on measured pressure data rather than SOC.

The PRR Taper method tapers or reduces the PRR after certain criteria have been met so that the ramp pressure reaches its maximum value at the same time that the CHSS pressure reaches the pressure target. With PRR Taper utilized, the ramp pressure is gradually reduced instead of abruptly, the PRR is controlled all the way until the pressure target is reached, the maximum possible pressure control margin is realized, and vehicles will receive consistently excellent SOC.

PRR Taper monitors the difference between the ramp pressure Pᵣₐₘₚ and the CHSS pressure. This difference in pressure is calculated as AP. AP is subtracted from the maximum ramp pressure to calculate a threshold value, which when reached, PRR Taper is implemented. PRR Taper can be implemented for both communications fueling and non-communications fueling. With communications fueling, the CHSS pressure is represented by the communicated measured pressure MP. For non-communications fueling, the CHSS pressure is represented by a “synthetic” measured pressure MP_{calc}.

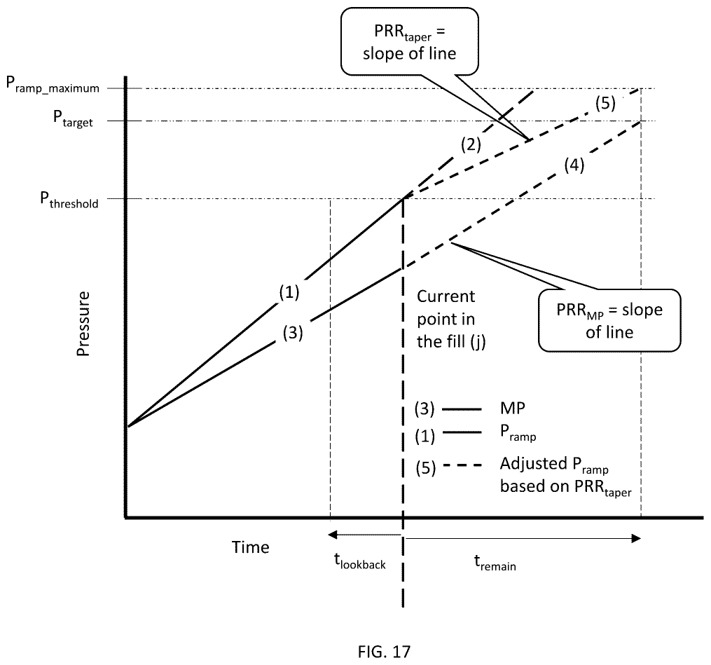

FIG. 17 illustrates the PRR Taper method. The timestep j represents the current timestep in the fueling event. The solid line labeled (1) represents the ramp pressure from the beginning of the main fueling time until the current timestep j. The dashed line labeled (2) is a projection of the ramp pressure at the current PRR. The solid line labeled (3) represents the CHSS pressure from the beginning of the main fueling time until the current timestep j. The dashed line labeled (4) is a projection of the CHSS pressure based on the slope or rate of change of the CHSS pressure from the current timestep to a previous timestep defined by t_{lookback}. The dashed line labeled (5) shows the projection of the ramp pressure at a reduced PRR so that the ramp pressure reaches its maximum value P_{ramp_maximum} at the same time as the CHSS pressure reaches the pressure target.

The equations used to implement PRR Taper are provided below with an explanation of their function.

The pressure drop between the ramp pressure and the CHSS pressure is calculated each timestep j and named ΔP. For communications fueling, the CHSS pressure is represented by MP and for non-communications fueling, the ramp pressure is represented by MP_{calc}.

$$Δ {P}_{( j )} = {P}_{ramp ( j )} - {MP}_{( j )} ( communications fueling )$$

$$OR$$

$$Δ {P}_{( j )} = {P}_{ramp ( j )} - {MP}_{calc ( j )} ( non - communications fueling )$$

Next, a threshold pressure P_{threshold} is calculated by subtracting AP from the maximum ramp pressure P_{ramp_maximum}.

P_{ramp_maximum} is a discretionary value selected by the dispenser, although it should be set as high as practically possible.

$${P}_{threshold} = {P}_{ramp \_ maximum} - Δ {P}_{( j )}$$

Pᵣₐₘₚ is compared to P_{threshold} and when it is greater than or equal to it, along with the timestep j being higher than the lookback period t_{lookback}, then a flag variable PRR_TAPER_FLAG is activated (set to TRUE).

$$IF {P}_{ramp ( j )} \geq {P}_{threshold} AND j > {t}_{lo okback}$$

$$THEN$$

$$PRR\_TAPER \_FLAG = TRUE$$

END IF

The next IF condition checks if the flag variable is set to FALSE or TRUE. If it is still set to FALSE, then PRR Taper is not active. If it is set to TRUE, then PRR Taper is active and PRR Taper is calculated.

IF PRR_TAPER_FLAG=TRUE

END IF

The first step in the PRR Taper method is to calculate the PRR of the CHSS pressure by comparing the current CHSS pressure, MP₍ⱼ₎ or MP_{calc(j)}, to a previous CHSS pressure t_{lookback} seconds ago. This PRR is named PRRMP. PRRMP is updated each timestep. t_{lookback} is set to 30 seconds.

$${PRR}_{MP ( j )} = \frac{( {MP}_{( j )} - {MP}_{( j - tloo kback )}}{tlookback} ( communications fueling )$$

$$OR$$

$${PRR}_{MP ( j )} = \frac{( {MP}_{calc ( j )} - {MP}_{calc ( j - tl ookback )}}{tlookback} ( non - communications fueling )$$

PRR_{MP} is used to project the amount of time required for the CHSS pressure to achieve the target pressure P_{target}. This time is named tᵣₑₘₐᵢₙ. tᵣₑₘₐᵢₙ is calculated by subtracting the current CHSS pressure, MP₍ⱼ₎ or MP_{calc(j)}, from the target pressure P_{target} and dividing this by PRR_{MP}.

$${t}_{remain ( j )} = \frac{{P}_{( ta rget \_ co mm )} - {MP}_{( j )}}{{PRR}_{MP ( j )}} ( communications fueling )$$

$$OR$$

$${t}_{remain ( j )} = \frac{{P}_{( t arget \_ non \_ comm )} - {MP}_{ca lc ( j )}}{{PRR}_{MP ( j )}} ( non - communications fueling )$$

After tᵣₑₘₐᵢₙ has been calculated, a reduced pressure ramp rate PRRtaper can be calculated. However, PRRtaper is only calculated if tᵣₑₘₐᵢₙ is greater than zero and Pᵣₐₘₚ is less than P_{ramp_maximum}. If either of these two conditions are not satisfied, PRRtaper is set to zero. If both conditions are satisfied, PRRtaper is calculated by subtracting Pᵣₐₘₚ from P_{ramp_maximum} and dividing by tᵣₑₘₐᵢₙ.

$$IF {t}_{remain ( j )} > 0 AND$$

$${P}_{ramp \_ maximum} > {P}_{ramp ( j )}$$

$$THEN$$

$${PRR}_{taper ( j )} = \frac{( {P}_{ramp \_ maximum} - {P}_{ramp ( j )} )}{{t}_{remain ( j )}}$$

$$ELSE$$

$${PRR}_{ta per ( j )} = 0$$

END IF

Finally, the pressure ramp rate PRR (which is used for control) is set to the lower of PRR_{calculated}, which is the PRR calculated by the fueling protocol (e.g. MC Formula pressure ramp rate equation), a maximum pressure ramp rate PRRₘₐₓ (a value determined by the fueling protocol), and PRRtaper.

$${PRR}_{( j )} = MINIMUM [ {PRR}_{calculated ( j )} , {PRR}_{max} , {PRR}_{taper ( j )} ]$$

If the PRR_TAPER_FLAG is still set to FALSE, then PRR (is set to the lower of PRR_{calculated} and PRRₘₐₓ.

ELSE

$${PRR}_{( j )} = MINIMUM [ {PRR}_{calculated ( j )} , {PRR}_{max} ]$$

END IF

The formulas above are calculated every timestep j. Also note that once the conditions for setting the PRR_TAPER_FLAG to TRUE have been met, PRR_TAPER_FLAG remains set to TRUE for the remainder of the fueling event. This is to prevent the PRR from “hunting” or changing drastically back and forth, which could occur if during one timestep, the flag conditions are TRUE and the next timestep, the flag conditions are FALSE and vice versa.

The implementation of PRR Taper for communications fueling and non-communications fueling is identical, except that for non-communications fueling, the CHSS pressure is represented by MPcalc and the target pressure is represented by Ptarget_non_comm.

MPcalc is calculated by first determining a parameter named K₀, which is a constant and relates the pressure drop across a flow restriction as a function of the square of the mass flow rate and the density, as shown in the following equation.

$$Δ P = {K}_{0} \frac{{\dot{m}}^{2}}{ρ}$$

This means that once K₀ has been calculated, the CHSS pressure (MP_{calc}) can be calculated by utilizing the station pressure, fuel delivery temperature, and mass flow rate as per the equation below. In this equation, the density is calculated by using an equation of state for hydrogen as a function of the station pressure and fuel delivery temperature.

$${MP}_{calc} = {P}_{station} - {K}_{0} \frac{{\dot{m}}^{2}}{ρ}$$

The accuracy of the K₀ calculation is dependent on the accuracy of the mass flow rate measurement, the station pressure measurement, and density calculation. The magnitude of the mass flow rate is also important since K₀ is determined by the difference in the station pressure measured when there is mass flow and when there isn't mass flow. The larger the pressure drop, the more accurate the calculation of K₀ since the effect of error in the pressure measurement is smaller. There will always be some error in the calculation of K₀, and even the K0 method itself has some error since it is essentially an estimation approach. To account for these inaccuracies, a parameter Pₐ can be added to the MP_{calc} equation to increase the value of MP_{calc} to ensure it is sufficiently conservative. Pₐ is a discretionary value determined by the dispenser.

$${MP}_{calc} = {P}_{station} - {K}_{0} \frac{{\dot{m}}^{2}}{ρ} + {P}_{a}$$

Another fueling method may be referred to as an “Adaptable T_{gas} Throttle Method”. This method provides a means to reduce and modulate the pressure ramp rate of a hydrogen fueling protocol to ensure that the maximum gas temperature limit of the CHSS is not exceeded, while also doing so in a manner that maximizes fueling performance (i.e. minimizes the fueling time). The method does this by calculating a threshold CHSS gas temperature above which the method is applied. Prior to this threshold being exceeded the fill utilizes the normal fueling protocol control (which can be a variety of approaches, including a fixed average pressure ramp rate, a dynamic pressure ramp rate such as used in the MC Formula protocol, etc.). This threshold temperature is dynamically calculated as a function of the pressure drop between the dispenser ramp press or the dispenser pressure measurement (station pressure) and the in-tank or CHSS gas pressure measurement. The reason the pressure drop is utilized is that when this pressure drop is high, changes in the dispenser pressure ramp rate have less effect on the mass flow rate or pressure ramp rate within the CHSS, which in turn affect the gas temperature rise. Therefore, when the pressure drop is high, it is necessary to utilize a lower threshold temperature to begin the pressure ramp rate reduction and modulation earlier in the fill. When the pressure drop is low, the threshold temperature is higher and the pressure ramp rate reduction/modulation occurs later in the fill.

The Adaptable T_{gas} Throttle method uses an equation which reduces and modulates the pressure ramp rate after the threshold temperature has been exceeded. This equation also uses an adaptable parameter in the denominator. The adaptable parameter is again a function of the pressure drop between the dispenser ramp pressure or station pressure and the CHSS gas pressure. The pressure ramp rate equation causes the pressure ramp rate to be reduced as the gas temperature rises. When the adaptable parameter in the denominator is large due to a high pressure drop, the reduction in the pressure ramp rate in relation to the rise in gas temperature is larger. As the pressure drop decreases later in the fill, the adaptable parameter in the denominator gets smaller, which makes the reduction in the pressure ramp rate in relation to the rise in gas temperature smaller. In essence, this equation is designed so that the pressure ramp rate is reduced sufficiently to avoid overshooting the maximum gas temperature in the CHSS, which can occur after the threshold temperature is breached and the pressure drop is still high (typically in the early to middle part of the fill), while at the same time keeping the pressure ramp rate high enough in the latter part of the fill so that the gas temperature approaches the target gas temperature. In summary, this approach uses an adaptable parameter to determine when the pressure ramp rate throttling begins and uses an adaptable parameter to regulate the pressure ramp rate once throttling begins.

There are two implementations of the Adaptable Tgas Throttle methodology described. The first implementation is referred to simply as “Adaptable Tgas Throttle” and the second implementation is referred to as “Adaptable Tgas Throttle with Self-Adjusting Parameters.” This second implementation calculates adjustments to some of the parameters based on the measured “noise” or “fluctuations” in the CHSS gas temperature T_{gas_high}. T_{gas_high} is supposed to represent the highest “bulk-average” gas temperature in each of the tanks in the CHSS. However, in practice the measurement of T_{gas_high} is not a perfect representation of the bulk-average gas temperature and is influenced by many factors, including the placement of the temperature sensor in the tank and the amount of mixing of the gas in the tank, which is in turned influenced by the gas injector geometry and the aspect ratio of the tank. The problem these fluctuations in T_{gas_high} present to the Adaptable Tgas Throttle control algorithm is that as T_{gas_high} approaches T_{gas_target}, T_{gas_high} can momentarily spike above T_{gas_target}. If T_{gas_target} is set at or near T_{gas_max} (the maximum allowed gas temperature in the CHSS), then the fill must stop. To counter this, T_{gas_target} must be set lower, which causes the fueling time to be longer. There are two approaches to dealing with fluctuations in T_{gas_high}. In the first implementation of the Adaptable Tgas Throttle, the user defines sufficiently conservative parameter values (a, b, and T_{gas_target}) to deal with the inherent fluctuations in T_{gas_high}. The second approach is to implement a method whereby the fluctuations in T_{gas_high} are measured, and adjustments are automatically made to the parameters based on the amplitude of these fluctuations. This second approach is best suited to a hydrogen fueling station with many different makes and models of vehicles fueling, since the fluctuations in T_{gas_high} for each vehicle can be different, and fueling performance is automatically optimized for each vehicle.

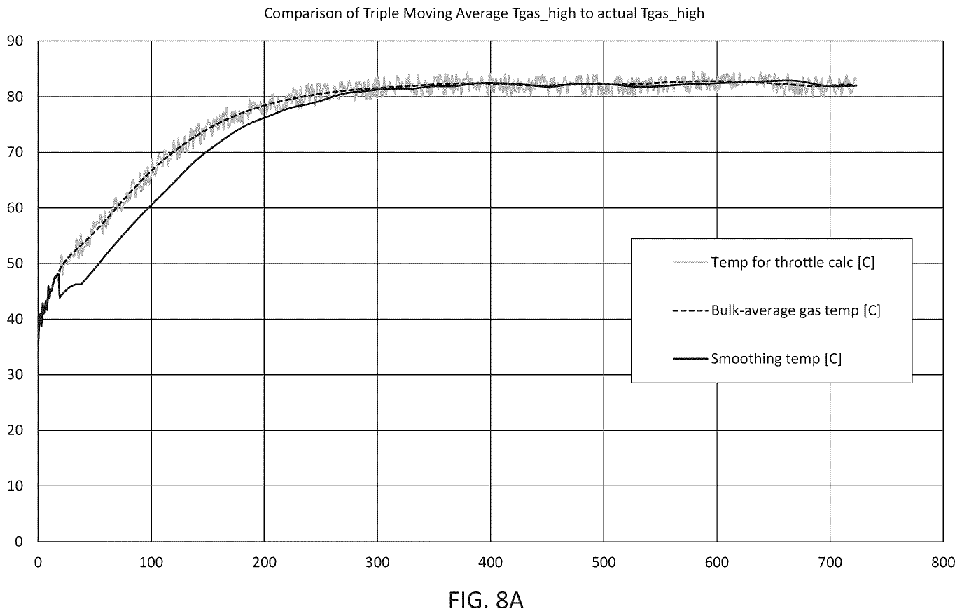

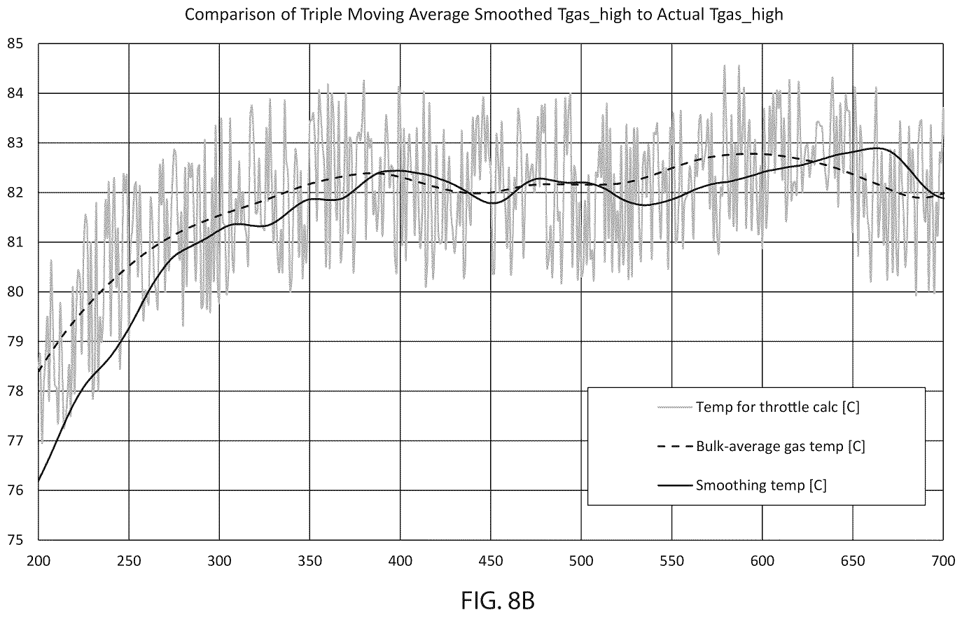

To reduce the fluctuations in the pressure ramp rate (PRR) caused by fluctuations in T_{gas_high}, a noise filter is implemented to smooth these fluctuations. A number of different noise filters were investigated and can be used, but a triple moving average (TMA) of the CHSS gas temperature demonstrated the best combination of effectiveness and simplicity. FIGS. 8A and 8B illustrate the TMA (solid line), which is a reasonable approximation of the bulk average CHSS gas temperature (dashed line). The TMA does introduce a time lag, but this doesn't have a material effect on the control since the precision of the PRR throttling is most important after the CHSS gas temperature has reached an asymptote during the latter part of the fill. The TMA is simply a moving average of a moving average of a moving average of the CHSS gas temperature. The length or periodicity of each moving average can be different, e.g. 15, 10, 5, or it can be the same, e.g. 10, 10, 10. Extensive computer fueling simulations were conducted and it was determined that a TMA of equal periodicities of 10 worked well.

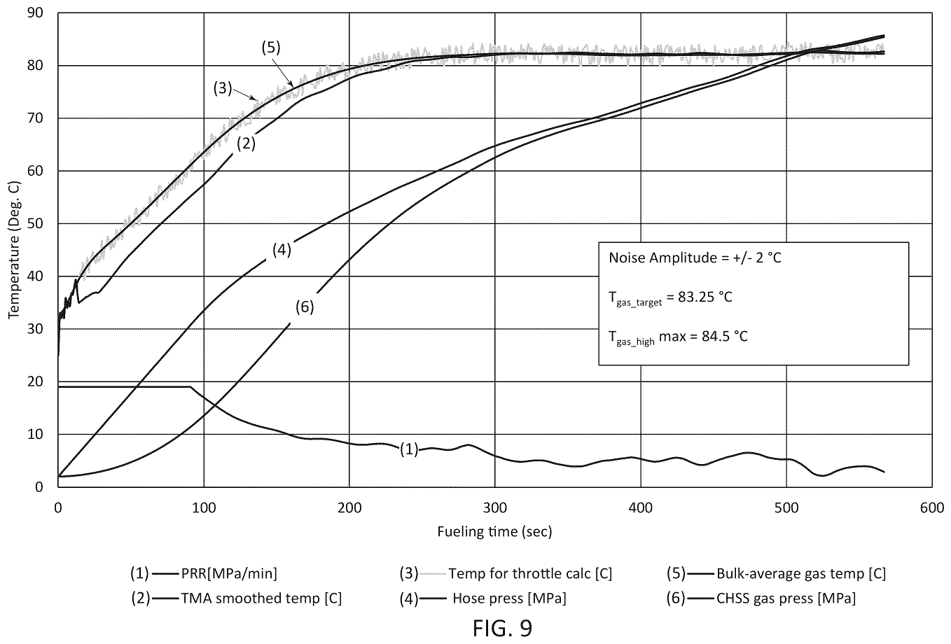

The effectiveness of the TMA in smoothing the CHSS gas temperature and consequently the PRR is illustrated in FIG. 9. Note in FIG. 9 that the T_{gas_target} value had to be set lower than 85° C. to avoid the CHSS gas temperature from momentarily spiking above the temperature limit. In this case, T_{gas_target} was set to 83.25° C., which resulted in a peak T_{gas_high} value of 84.5° C. Although this methodology is effective, a shortcoming of it is that each vehicle will have different levels of fluctuations in T_{gas_high}. So how should T_{gas_target} be set if the level required depends on the magnitude of these fluctuations? One way to deal with this is to set T_{gas_target} sufficiently low so that it is effective against all expected fluctuation levels in T_{gas_high} (e.g. a noise level of +/−5° C.). However, this approach increases the fueling time substantially, because the lower T_{gas_target} is set, the more the PRR is reduced, lengthening the fueling time. One option is for the vehicle OEM to measure the fluctuations in T_{gas_high} under a variety of fueling conditions and determine an appropriate T_{gas_target} value, which can then be communicated from the vehicle to the dispenser. An alternative approach is to utilize an approach whereby the T_{gas_target} value automatically adjusts to the fluctuations inherent in T_{gas_high}.

There are two control parameters in the Adaptable Tgas Throttle algorithm which need to be adjusted due to fluctuations in T_{gas_high}: T_{gas_target} and the adaptable denominator value AD. T_{gas_target} is explained above. AD is the denominator in the PRR throttle equation. The smaller the value of AD, the more sensitive PRR is to changes in T_{gas_high}, or T_{gas_smooth} (which is the TMA applied to T_{gas_high}). Therefore, with higher amplitude in the fluctuations of T_{gas_high}, T_{gas_target} needs to be reduced and the minimum value of AD needs to be increased. The minimum value of AD is determined by the parameter “b”.

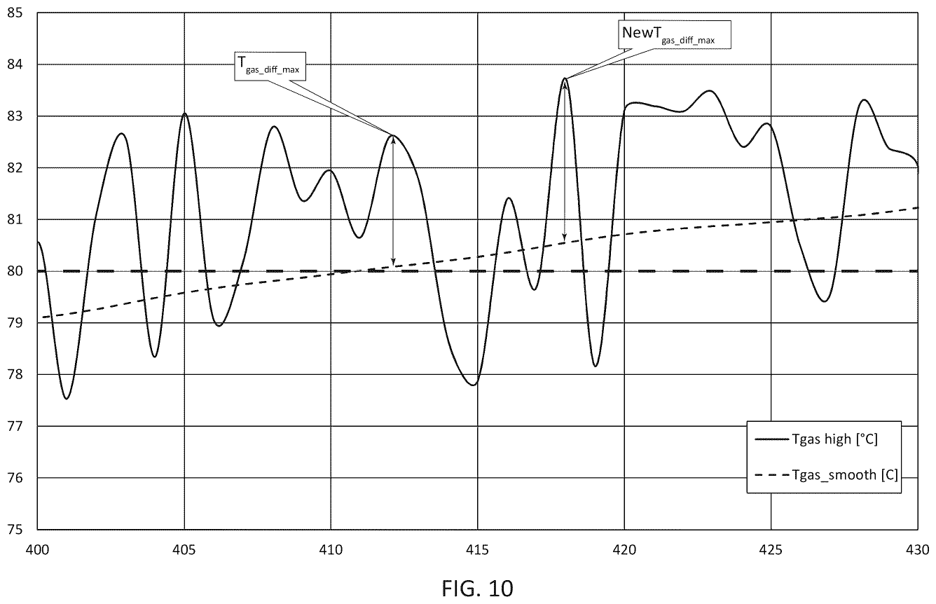

To determine the inherent fluctuations in T_{gas_high}, the difference between T_{gas_high} and T_{gas_smooth} is measured. This parameter is named T_{gas_diff}. T_{gas_diff} is measured after T_{gas_smooth} crosses above a threshold temperature named T_{gas_smooth_threshold}. Once T_{gas_diff} begins to be measured, the maximum value is recorded as T_{gas_diff_max}. This process is illustrated in FIG. 10.

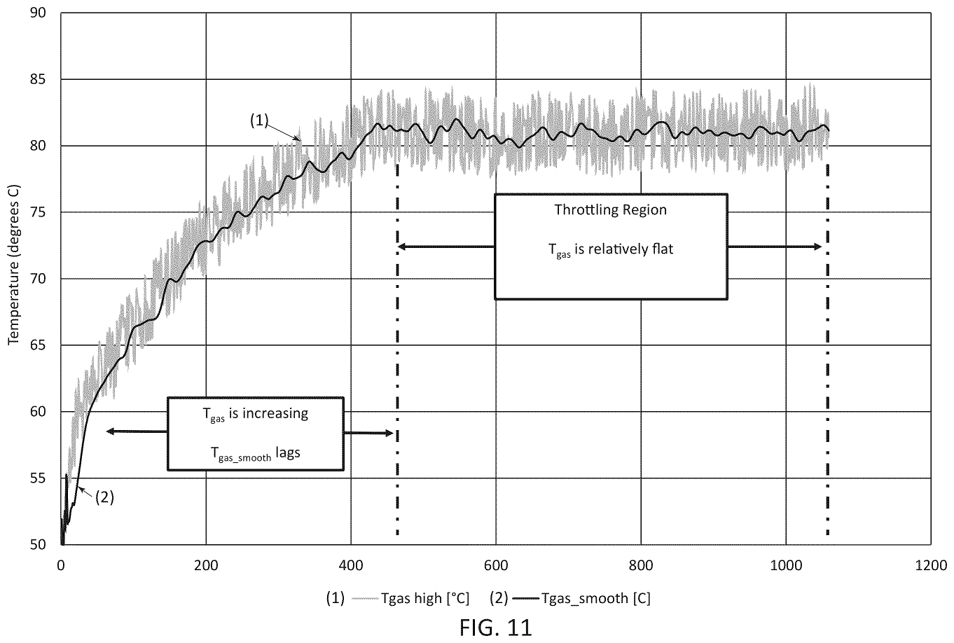

The reason that T_{gas_diff} is measured only after T_{gas_smooth} rises above T_{gas_smooth_threshold} is because early in the fill, the CHSS gas temperature is rising rapidly. As noted previously, T_{gas_smooth} lags due to the TMA smoothing function. If T_{gas_diff} is measured from the beginning of the fill, T_{gas_diff_max} will be artificially high due to this lag. Therefore, the objective is to set the T_{gas_smooth_threshold} value at a value where the CHSS gas temperature is naturally beginning to asymptote. Fueling simulations show that a value between 75° C. and 80° C. works well (although other values lower and higher could be used). Fueling performance is relatively insensitive to the T_{gas_smooth_threshold} value utilized within this range. This asymptote behavior in the CHSS gas temperature is illustrated in FIG. 11. This region where T_{gas_high} and T_{gas_smooth} are relatively flat is referred to as the throttling region and it is where the pressure ramp rate throttling is most critical to avoid exceeding the maximum gas temperature.

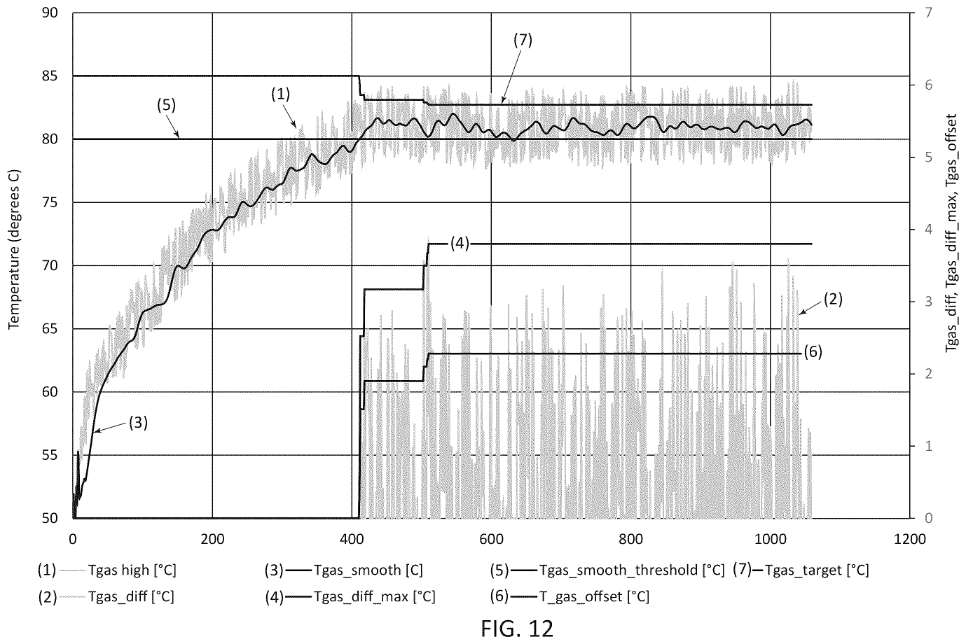

T_{gas_diff_max} is a measurement of the magnitude of fluctuation inherent in T_{gas_high}. Its purpose is to determine an appropriate setting for T_{gas_target} and the parameter “b”, which determines the minimum value of AD. To utilize T_{gas_diff_max} in this manner, a derivative parameter T_{gas_offset} is calculated. T_{gas_offset} is calculated by multiplying T_{gas_diff_max} by a parameter named T_{gas_offset_factor}, i.e. T_{gas_offset}=T_{gas_diff_max}×T_{gas_offset_factor}. T_{gas_target} is then calculated as follows: T_{gas_target}=T_{gas_max}−T_{gas_offset}. T_{gas_max} is the maximum CHSS gas temperature allowed (typically 85° C.). When T_{gas_smooth_threshold} has not yet been reached, T_{gas_target}=T_{gas_max}. “b” is calculated as follows: b=MAXIMUM [bₘᵢₙ, (T_{gas_offset_multiplier}×T_{gas_offset})]. bₘᵢₙ is a user defined parameter, but simulations show a value of 4 works well. When T_{gas_smooth_threshold} has not yet been reached, b=bₘᵢₙ. T_{gas_offset_factor} and T_{gas_offset_multiplier} are both user defined tuning parameters. Multiple fueling simulations were conducted to determine appropriate settings for these two parameters. These simulations demonstrated that T_{gas_offset_factor}=0.6 and T_{gas_offset_multiplier}=5 work well, but other values can be used. To illustrate the self-adjusting parameters in an example fill, see FIG. 12. This graph shows how T_{gas_target} changes based on T_{gas_diff_max} and thus T_{gas_offset}.

To confirm the robustness of the Adaptable Tgas Throttle with Self-Adjusting Parameters algorithm, approximately 150 computer fueling simulations were conducted at different ambient temperatures, fuel delivery temperatures, noise amplitudes in T_{gas_high}, initial CHSS pressures, CHSS Cv values, CHSS type 4 liner thermal conductivity values, CHSS type 3 liner properties, and CHSS surface to volume ratios. In other words, to test the robustness of this approach, all relevant parameters were varied over a wide range. In every simulation conducted, the peak CHSS gas temperature T_{gas_high} was kept below 85° C. (which was used as the T_{gas_max} setting). The highest peak gas temperature observed was 84.7° C.

Definitions applicable to both Adaptable Tgas Throttle and Adaptable Tgas Throttle with Self-Adjusting Parameters:

T_{gas_high}: the highest bulk average gas temperature in the CHSS (communicated from the vehicle to the station)

T_{gas_smooth}: a triple moving average of T_{gas_high} using a moving average length of TMAL. This parameter is only calculated in the self-adjusting parameters approach.

TMAL: The moving average length used in the triple moving average of T_{gas_high} to calculate T_{gas_smooth}. This parameter is only used in the self-adjusting parameters approach.

T_{gas_max}: the maximum gas temperature allowed for the CHSS (can be a user setting or can be communicated from the vehicle to the station)

T_{gas_target}: the practical allowable gas temperature in the CHSS (accounting for any needed tolerances—can be a user setting or can be a function of T_{gas_max})

T_{threshold}: Threshold temperature—when exceeded by T_{gas_high} or T_{gas_smooth} the PRR throttling algorithm is applied

T_{gas_smooth_threshold}: Another threshold temperature—when exceeded by T_{gas_smooth} T_{gas_diff} and T_{gas_diff_max} are calculated. This parameter is only used in the self-adjusting parameters approach.

T_{gas_diff}: A measurement of the difference between the current T_{gas_high} and the current T_{gas_smooth}. This measurement is only conducted in the self-adjusting parameters approach.

T_{gas_diff_max}: The maximum T_{gas_diff} measured during the fill up to and including the current timestep. This calculation is only conducted in the self-adjusting parameters approach.

T_{gas_diff_factor}: A user defined parameter utilized only in the self-adjusting parameters approach.

T_{gas_offset}: A parameter which is calculated as a function of T_{gas_diff_max} and utilized only in the self-adjusting parameters approach.

T_{gas_offset_multiplier}: A user defined parameter utilized only in the self-adjusting parameters approach.

P_{CHSS}: The gas pressure in the CHSS. In a multi-tank CHSS, P_{CHSS} is the lowest pressure in all of the tanks. (communicated from the vehicle to the station)

Pₛₜₐₜᵢₒₙ: The dispenser pressure

Pᵣₐₘₚ: The dispenser ramp pressure—the pressure the dispenser is targeting for each point in time during the fill

AP: A value representing the calculation of the current ramp pressure Pᵣₐₘₚ or current station pressure Pₛₜₐₜᵢₒₙ minus the current CHSS pressure P_{CHSS}

ΔPₘₐₓ: The maximum AP measured during the fill.

P_{final}: The final pressure used in the derivation of the t_{final} parameter used in MC Formula protocol, typically set at 1.25×NWP

Pₘᵢₙ: The initial pressure used in the derivation of the t_{final} parameter used in MC Formula protocol

t_{final}: A parameter used in the MC Formula protocol. It is a calculation of the minimum time required to fill from Pₘᵢₙ to P_{final} without exceeding the CHSS maximum gas temperature limit and the maximum flow rate limit. It is typically derived using computer fueling simulations.

PRR_{threshold}: The pressure ramp rate at the time that T_{gas_high}=T_{threshold} or a pressure ramp rate based on a control parameter such as t_{final}, e.g. PRR_{threshold}=(P_{final}−Pₘᵢₙ)/t_{final}

PRR: The pressure ramp rate for each time step throughout the fill. This is the control pressure ramp rate used to calculate the ramp pressure Pᵣₐₘₚ for each time step.

PRR_{calculated}: The pressure ramp rate calculated by the fueling protocol, for example, PRR_{MC} using the MC Formula fueling protocol algorithm. PRR_{calculated} is calculated throughout the fill and is used as PRR prior to the point in the fill when T_{gas_high} or T_{gas_smooth} exceeds T_{threshold}

PRRₜₕᵣₒₜₜₗₑ: The pressure ramp rate calculated by the Adaptable Tgas Throttle algorithm.

a: A dimensionless user defined parameter, which is multiplied by ΔP. Parameter “a” is a user defined input which can be tuned for the best performance in a particular application. It can also be a function of another parameter such as the initial CHSS pressure.

b: A dimensionless user parameter used to calculated a minimum value for AD. In the non-self adjusting parameter implementation “b” is a user defined input which can be tuned for the best performance in a particular application.

bₘᵢₙ: A dimensionless user parameter used to calculate a minimum value of “b” and utilized only in the self-adjusting parameters approach.

An example implementation of the Adaptable T_{gas} Throttle fueling method is as follows:

### Equations:

$$Set i = 0 \qquad ( Eq 4.1 )$$

$$Set Δ P = 0$$

$$Set Δ {P}_{max} = 0$$

$$Set a ( user input - one embodiment IF {P}_{0} < 10 , a = 3 , ELSE a = 4 )$$

$$Set b ( user input - one embodiment b = 4 )$$

$$Set {T}_{gas \_ max} ( user input or received via communications from vehicle \text{} - one embodiment {T}_{gas \_ max} = 85 ° C . )$$

$$Set {T}_{gas \_ target} ( \text{} user input or a function of {T}_{gas \_ max} - one embodiment {T}_{gas \_ tar get} = {T}_{gas \_ max} , another embodiment {T}_{gas \_ tar get} = {T}_{gas \_ max} - Δ T where Δ T is a user input )$$

$$Begin Fueling$$

$$Calculate {PRR}_{calculated ( i )} according to the fueling protocol being utilized \qquad ( Eq 4.2 )$$

$$Δ {P}_{( i )} = {P}_{ramp ( i )} - {P}_{CHSS ( i )} ( one embodiment ) ; or Δ {P}_{( i )} = {P}_{station ( i )} - {P}_{CHSS ( i )} ( another embodiment ) \qquad ( Eq 4.3 )$$

$$IF Δ {P}_{( i )} > Δ {P}_{max} , THEN Δ {P}_{max} = Δ {P}_{( i )}$$

$$END IF$$

$${T}_{threshold} = {T}_{gas \_ tar get} - a Δ {P}_{max} ( one embodiment ) \qquad ( Eq 4.4 )$$

$${T}_{threshold} = {T}_{gas \_ tar get} - a Δ P ( another embodiment )$$

$$IF {T}_{gas \_ high ( i )} \geq {T}_{threshold} \qquad ( Eq 4.5 )$$

$$THEN$$

$${PRR}_{threshold ( i )} = PRR at the timestep when {T}_{gas \_ high} \geq {T}_{threshold} fo r the first time ( one embodiment ) ; OR \qquad ( Eq 4.6 )$$

$${PRR}_{threshold ( i )} = \frac{( {P}_{final} - {P}_{min} )}{{t}_{final ( i )}} ( another embodiment )$$

$${AD}_{( i )} = MAXIMUM [ b , ( a Δ {P}_{( i )} ) ] \qquad ( Eq 4.7 )$$

$${PRR}_{t hrottle ( i )} = MAXIMUM [ 0 , \frac{{PRR}_{threshold ( i )} \times ( {T}_{gas \_ target} - {T}_{gas \_ high ( i )} )}{{AD}_{( i )}} ] \qquad ( Eq 4.8 )$$

$${PRR}_{( i )} = MINIMUM [ {PRR}_{calcaulted ( i )} , {PRR}_{throttle ( i )} ] \qquad ( Eq 4.9 )$$

$$ELSE \qquad ( Eq 4.1 )$$

$${PRR}_{( i )} = {PRR}_{calcaulted ( i )}$$

$$END IF \qquad ( Eq 4.11 )$$

$$Calculate the ramp pressure for the next time step i + 1 :$$

$${P}_{ramp ( i + 1 )} = {P}_{ramp ( i )} + {PRR}_{( i )}$$

$$i = i + 1 and Loop Back to Eq 4.2 \qquad ( Eq 4.12 )$$

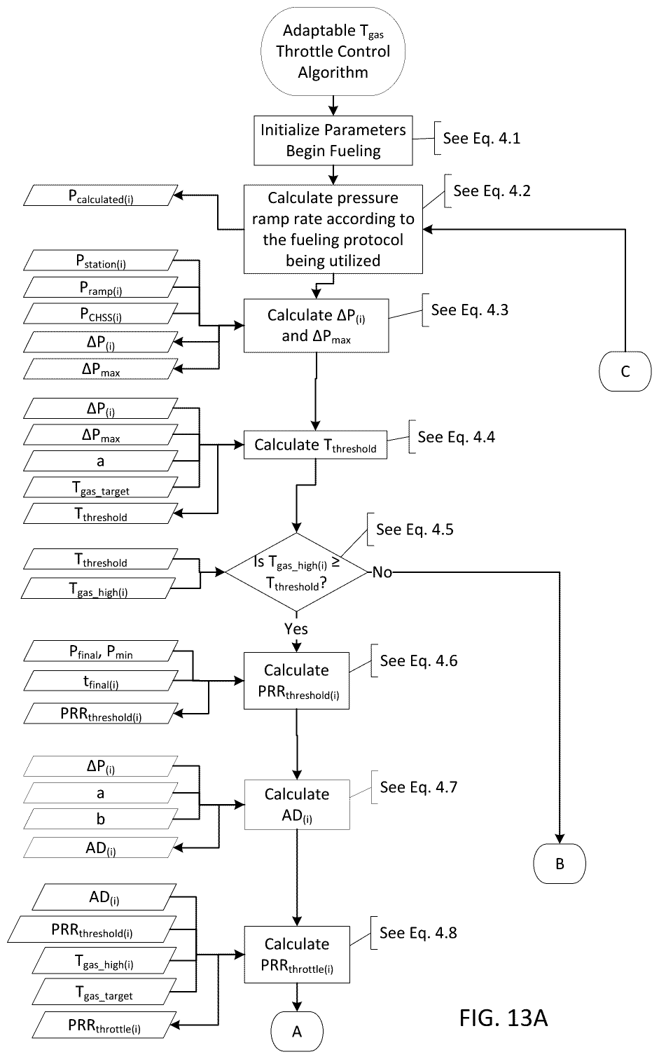

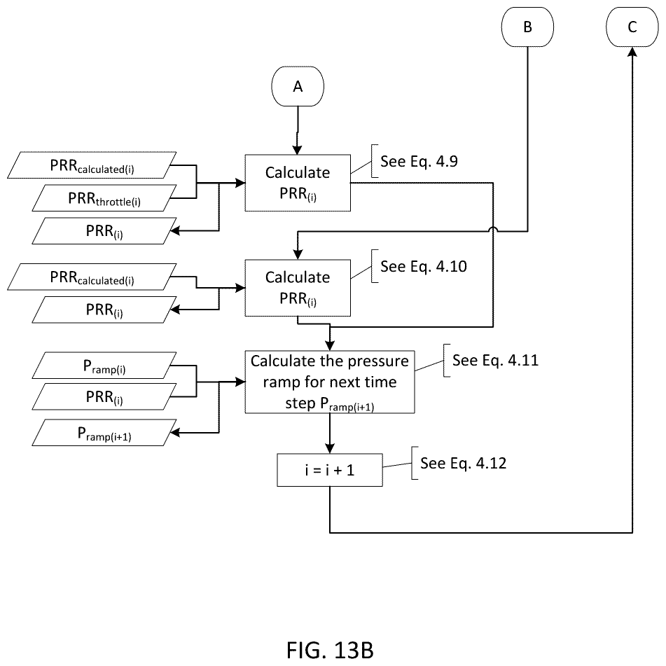

Flow Chart: FIGS. 13A & 13B contain a flow chart showing the implementation of Eq. 4.1 through 4.12 set forth above. It is noted that the algorithm in the flow chart may have a calculation frequency suitable for the particular application. One example calculation frequency is 1 Hz.

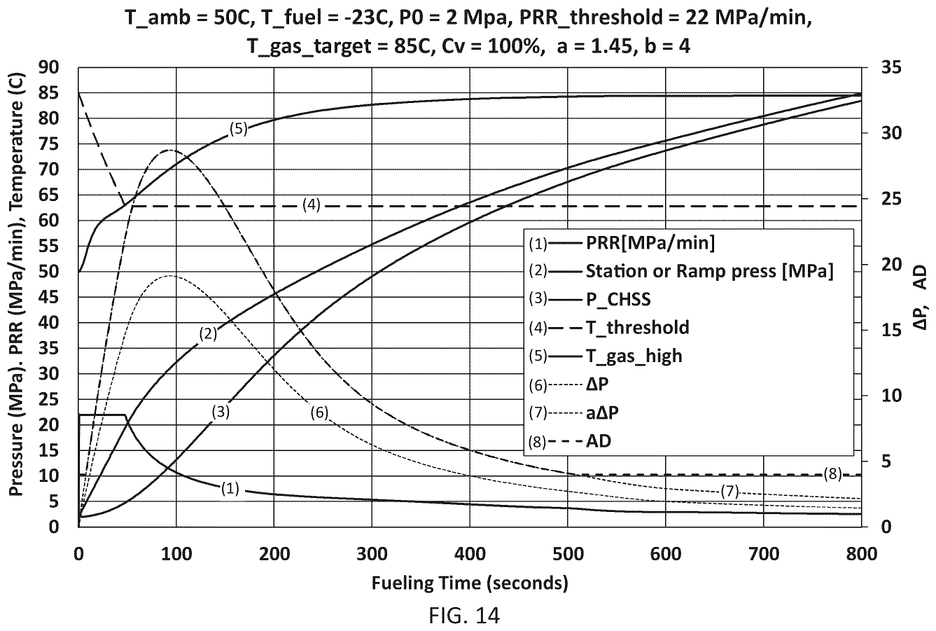

FIG. 14 illustrates the operation of the Adaptable T_{gas} Throttle method. The illustration shows station pressure (which in this case also represents the ramp pressure), tank pressure, and tank temperature versus time. The line labeled (1), represents the pressure ramp rate. The line labeled (2), represents the station or ramp pressure. The line labeled (3), represents the tank pressure (P_{CHSS}). The line, labeled (4), represents the threshold temperature. The line, labeled (5), represents the tank gas temperature (T_{gas_high}). The line, labeled (6), represents ΔP. The line, labeled (7), represents the product of a and ΔP. The line, labeled (8), represents AD.

An example implementation of the Adaptable T_{gas} Throttle with Self-Adjusting Parameters fueling method is as follows:

### Equations:

$$Set i = 0 \qquad ( Eq 5.1 )$$

$$Set Δ P = 0$$

$$Set Δ {P}_{max} = 0$$

$$Set {T}_{gas \_ diff} = 0$$

$$Set {T}_{gas \_ diff \_ max} = 0$$

$$Set {T}_{gas \_ smooth} = {T}_{gas \_ high}$$

$$Set a ( user input - one embodiment IF {P}_{0} < 10 , a = 3 , ELSE a = 4 )$$

$$Set {b}_{min} ( user input - one embodiment {b}_{min} = 4 )$$

$$Set TMAL ( user input - one embodiment TMAL = 10 )$$

$$Set {T}_{{gas}_{-} max} ( user input or received via communications from vehicle - one embodiment {T}_{gas \_ max} = 85 ° C . )$$

$$Set {T}_{gas \_ target} ( user input or a function of {T}_{gas \_ max} - one embodiment {T}_{gas \_ tar get} = {T}_{gas \_ max} )$$

$$Set {T}_{gas \_ s mooth \_ t hreshold} ( \text{} user input - one embodiment {T}_{gas \_ smooth \_ threshold} = 77 ° C . )$$

$$Set {T}_{gas \_ diff \_ factor} ( user input - one embodiment {T}_{gas \_ diff \_ factor} = 0 \text{.6} )$$

$$Set {T}_{gas \_ offset \_ multiplier} ( user input - one embodiment {T}_{gas \_ offset \_ multiplier} = 5 )$$

$$Begin Fueling$$

$$Calculate {PRR}_{calculated ( i )} according to the fueling protocol being utilized \qquad ( Eq 5.2 )$$

$${T}_{{gas}_{-} {MA}_{-} 1 ( i )} = \frac{{\sum }_{( i - TMAL )}^{i} {T}_{{gas}_{-} high ( i )}}{TMAL} \qquad ( Eq 5.3 )$$

$${T}_{{gas}_{-} {MA}_{-} 2 ( i )} = \frac{{\sum }_{( i - TMAL )}^{i} {T}_{{gas}_{-} {MA}_{-} 1 ( i )}}{TMAL}$$

$${T}_{gas \_ smooth ( i )} = \frac{{\sum }_{( i - TMAL )}^{i} {T}_{{gas}_{-} {MA}_{-} 2 ( i )}}{TMAL}$$

$$Note : in the above equations if i - TMAL < 0 , then i - TMAL = 0$$

$$Δ {P}_{( i )} = {P}_{ramp ( i )} - {P}_{CHSS ( i )} ( one embodiment ) ; or Δ {P}_{( i )} = {P}_{station ( i )} - {P}_{CHSS ( i )} ( another embodiment ) \qquad ( Eq 5.4 )$$

$$IF Δ {P}_{( i )} > Δ {P}_{max} , THEN Δ {P}_{max} = Δ {P}_{( i )}$$

$$END IF$$

$${T}_{threshold} = {T}_{gas \_ target} - a Δ {P}_{max} ( one embodiment ) \qquad ( Eq 5.5 )$$

$${T}_{threshold} = {T}_{gas \_ target} - a Δ P ( another embodiment )$$

$$IF {T}_{gas \_ smooth ( i )} \geq {T}_{threshold} \qquad ( Eq 5.6 )$$

$$THEN$$

$${PRR}_{threshold ( i )} = PRR at the timestep when {T}_{gas \_ high} \geq {T}_{threshold} fo r the first time ( one embodiment ) ; OR \qquad ( Eq 5.7 )$$

$${PRR}_{threshold ( i )} = \frac{( {P}_{final} - {P}_{min} )}{{t}_{final ( i )}} ( another embodiment )$$

$$IF {T}_{gas \_ smooth ( i )} \geq {T}_{gas \_ smooth \_ threshold} \qquad ( Eq 5.8 )$$

$$THEN \qquad ( Eq 5.9 )$$

$${T}_{gas \_ diff ( i )} - {T}_{gas \_ high ( i )} - {T}_{gas \_ smooth ( i )}$$

$$ELSE \qquad ( Eq 5.1 )$$

$${T}_{gas \_ diff ( i )} = 0$$

$$END IF$$

$$IF {T}_{gas \_ diff ( i )} > {T}_{gas \_ diff \_ max} THEN {T}_{gas \_ diff \_ max} = {T}_{gas \_ diff ( i )} \qquad ( Eq 5.11 )$$

$$END IF$$

$${T}_{gas \_ offset} = {T}_{gas \_ diff \_ factor} \times {T}_{gas \_ diff \_ max} \qquad ( Eq 5.12 )$$

$${T}_{gas \_ target} = {T}_{ga {s}_{\_} max} - {T}_{gas \_ offset} \qquad ( Eq 5.13 )$$

$$b = MAXIMUM [ {b}_{min} , {T}_{gas \_ offset \_ multiplier} \times {T}_{gas \_ offset} ] \qquad ( Eq 5.14 )$$

$${AD}_{( i )} = MAXIMUM [ b , ( a Δ {P}_{( i )} ) ] \qquad ( Eq 5.15 )$$

$${PRR}_{throttle ( i )} = MAXIMUM [ 0 , \frac{{PRR}_{t hreshold ( i )} \times ( {T}_{gas \_ target} - {{T}_{gas \_ smooth}}_{( i )} )}{{AD}_{( i )}} ] \qquad ( Eq 5.16 )$$

$${PRR}_{( i )} = MINIMUM [ {PRR}_{calcaulted ( i )} , {PRR}_{t hrottle ( i )} ] \qquad ( Eq 5.17 )$$

$$ELSE \qquad ( Eq 5.18 )$$

$${PRR}_{( i )} = {PRR}_{calcaulted ( i )}$$

$$END IF \qquad ( Eq 5.19 )$$

$$Calculate the ramp pressure for the next time step i + 1 :$$

$${P}_{ramp ( i + 1 )} = {P}_{ramp ( i )} + {PRR}_{( i )}$$

$$i = i + 1 and Loop Back to Eq 5.2 \qquad ( Eq 5.2 )$$

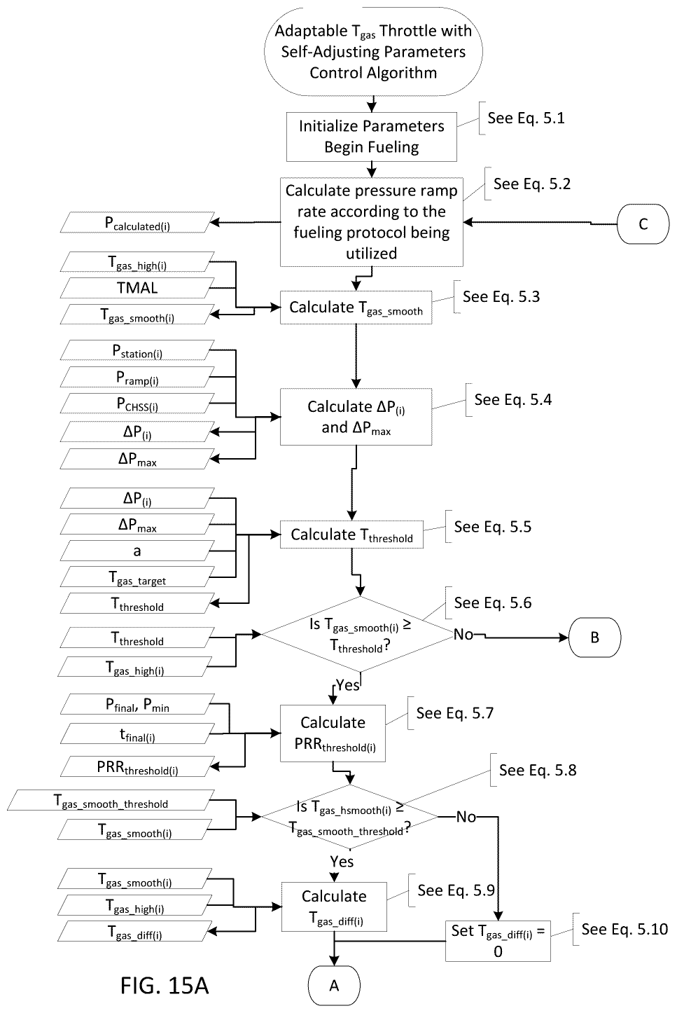

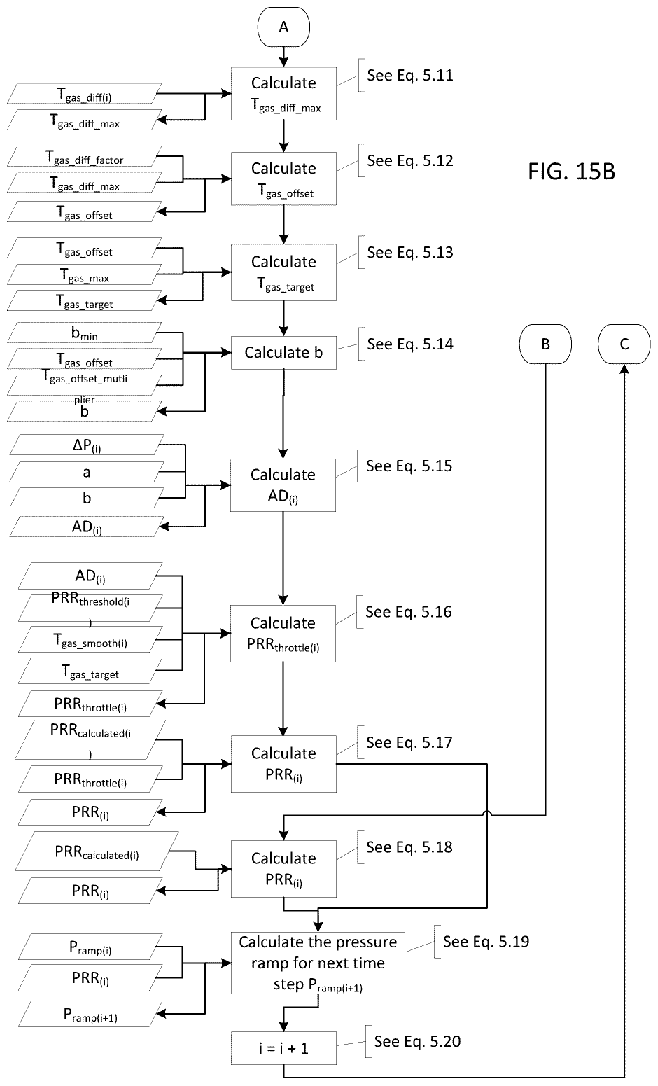

Flow Chart: FIGS. 15A & 15B contain a flow chart showing the implementation of Eq. 5.1 through 5.20 set forth above. It is noted that the algorithm in the flow chart may have a calculation frequency suitable for the particular application. One example calculation frequency is 1 Hz.

### Implementation of the Fueling Methods

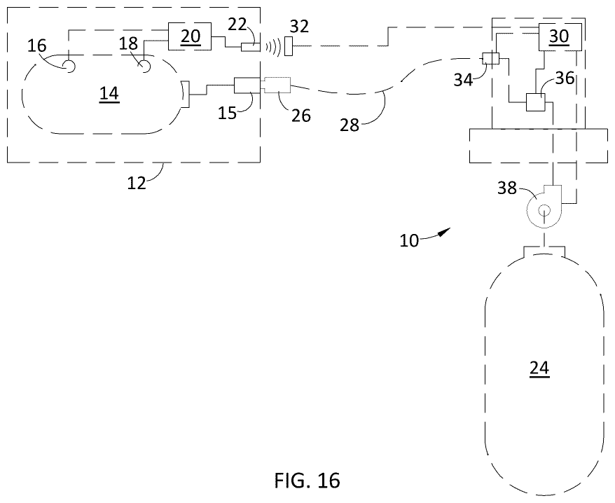

The fueling methods described above include algorithms that can be implemented by a hydrogen station dispenser. The elements that are required to practically implement these fueling methods are illustrated in FIG. 16.

FIG. 16 illustrates a representative example filling station 10 in conjunction with a vehicle 12. The vehicle 12 includes a gaseous fuel storage tank 14 having a known volume “V” and equipped with a fill receptacle 15. The vehicle 12 includes a pressure sensor 16 operable to sense a gas pressure in the tank 14 and produce a signal representative thereof. The vehicle 12 includes a temperature sensor 18 operable to sense a gas temperature in the tank 14 and produce a signal representative thereof. The vehicle 12 includes an electronic controller 20 operable to receive the signals from the sensors and transmit that information along with other pertinent information such as the tank volume V using a wired or wireless data transmitter 22 such as the illustrated infrared transmitter.

While FIG. 16 illustrates a single tank, it will be understood that there can be multiple storage vessels that comprise the compressed hydrogen storage system. In the rendition with multiple storage vessels, the gas temperature measurement “T” would be used to determine the lowest gas temperature T_{gas_low} and the highest gas temperature T_{gas_high}.

Furthermore, it is noted that the use of the vehicle is merely an illustrative example, and the method described herein are suitable for application to a filling process for any gas storage container.

The filling station 10 includes a fuel supply 24 (e.g. hydrogen). The fuel may be stored as liquid, low-pressure gas, or high-pressure gas, and is dispensed in gaseous form through a nozzle 26 which is disposed at a distal end of a fill hose 28 and which is configured to be coupled to the fill receptacle 15. It will be understood that a filling station 10 of this type may include conventional ancillary equipment for handling the fuel such as heat exchangers, pumps, compressors, and/or valves. The filling station 10 includes an electronic controller 30.

The controller 30 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC).

The filling station 10 is equipped with a wired or wireless data receiver 32 configured to receive data from the data transmitter 22 of the vehicle 12, such as the illustrated infrared receiver mounted on the nozzle 26. The data receiver 32 is operably connected to the controller 30.

The filling station 10 includes a gas property sensor 34 which may be disposed in a proximate end of the fill hose 28. The gas property sensor 34 is operable to sense one or more properties of the gaseous fuel flowing through the fill hose 28 generate a signal representative thereof. One example of a sensed property is pressure. Another example is flow rate (volume or mass). And another example is the gas temperature.

The filling station 10 includes at least one throttling device operable to affect some aspect of the flow of gaseous fuel. One example of a throttling device is a controllable valve, shown schematically at 36. This could be, for example a pressure regulating valve operably connected to the controller 30 in such a way that the controller 30 can change the pressure set point of the pressure regulating valve. Another example of a controllable valve 36 would be a flow metering valve operated by an actuator operably connected to the controller 30 such that the controller 30 can change the flow rate through the flow metering valve.

Another example of a throttling device is a variable-speed pump 38 operating control by the controller 30.

Operation of the throttling device, e.g. modulation of a pressure, flow rate, or pump speed is effective to control a property of the gaseous fuel flow 34 measured by the gas property sensor 34. The controller 30 may be programmed to execute one or more of the throttle control algorithms described above and to operate the throttling device in a feedback loop to produce the desired pressure ramp rate (PRR) computed within the throttle control algorithm.

The foregoing has described a gaseous fueling method. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of filling a tank with gaseous fuel, comprising:
delivering a gas from a filling station to the tank;
while delivering the gas:
communicating a gas temperature measurement and a gas pressure measurement from the tank to the filling station;
based on the gas temperature measurement, computing a time remaining (tremain_Tgas) for a temperature of the gas in the tank to reach a predetermined target temperature;
based on the gas temperature and gas pressure measurements, computing a time remaining (tremain_SOC) for a state of charge of the gas in the tank to reach a predetermined target state of charge;
determining a difference between (tremain_Tgas) and (tremain_SOC); and
modulating a pressure ramp rate of the gas being delivered so as to reduce the difference between (tremain_Tgas) and (tremain_SOC).

2. The method of claim 1, wherein the tank is a hydrogen vehicle gas tank.

3. A method of filling a tank with gaseous fuel, comprising:
delivering a gas from a filling station to the tank, at a ramp pressure;
communicating a gas temperature measurement and a gas pressure measurement from the tank to the filling station;
increasing the ramp pressure at a pressure ramp rate (PRR_calculated) which is calculated using a preselected fueling protocol (PRR_calculated), until the ramp pressure exceeds a threshold value (P_threshold);
once the ramp pressure exceeds P_threshold:
based on the gas temperature and gas pressure measurements, computing a state of charge (SOC) based on density using an equation of state;
computing a rate of change of SOC (SOCRR) over a lookback period (t_lookback), and based on SOCRR, computing a time remaining (tremain_SOC) for a state of charge of the gas in the tank to reach a predetermined target state of charge;
computing a new pressure ramp rate PRR_SOC;
comparing PRR_SOC to (PRR_calculated); and
in response to PRR_SOC being lower than PRR_calcuated, setting the pressure ramp rate to PRR_SOC.

4. The method of claim 3, wherein computing a new pressure ramp rate includes:
computing the rate of change of the ramp pressure (PRR_lookback) over a lookback period (t_lookback), and based on PRR_lookback, computing a time remaining (tremain_PRR) for the ramp pressure to reach a predetermined value (P_ramp_target);
determining a difference between (tremain_PRR) and (tremain_SOC); and
in response to this difference being a negative value, computing the new pressure ramp rate PRR_SOC based on tremain_SOC, so as to reduce an absolute value of the difference between tremain_PRR and tremain_SOC.

5. The method of claim 3, wherein computing a new pressure ramp rate includes:
computing the new pressure ramp rate PRR_SOC based on tremain_SOC.

6. The method of claim 3, wherein P_threshold is a preset value.

7. The method of claim 3, wherein P_threshold is a value based on a percentage of a nominal working pressure (NWP) of the tank.

8. The method of claim 3, wherein P_threshold is a function of P_ramp_target and a pressure drop measured between the ramp pressure and the pressure in the tank.

9. The method of claim 3, wherein P_threshold is a function of P_ramp_target and a pressure drop measured between a station pressure and the pressure in the tank.

10. The method of claim 3, wherein P_threshold is a function of P_ramp_target and a maximum pressure drop measured between the ramp pressure and the pressure in the tank.

11. The method of claim 3, wherein P_threshold is a function of P_ramp_target and a maximum pressure drop measured between the station pressure (P_station) and the pressure in the tank.

12. The method of claim 3, wherein P_threshold is a function of P_ramp_target, the current ramp pressure as a percentage of the P_ramp_target, and the SOC_target.

13. A method of filling a tank with gaseous fuel, comprising:
delivering a gas from a filling station to the tank, at a ramp pressure;
communicating a gas temperature measurement and a gas pressure measurement MP from the tank to the filling station;
increasing the ramp pressure at a pressure ramp rate (PRR_calculated) which is calculated using a preselected fueling protocol (PRR_calculated), until the ramp pressure exceeds a threshold value (P_threshold);
once the ramp pressure exceeds P_threshold:
computing a rate of change of MP (PRR_{MP}) over a lookback period (t_lookback), and based on PRR_{MP}, computing a time remaining (tᵣₑₘₐᵢₙ) for a pressure of the gas in the tank to reach a predetermined pressure (P_{target});
computing a new pressure ramp rate PRRₜₐₚₑᵣ; and
setting the pressure ramp rate to the lower of: PRRₜₐₚₑᵣ, the PRR calculated by the fueling protocol being utilized (PRR_{calculated}), and a maximum pressure ramp rate PRR_{MAX} calculated by the fueling protocol being utilized.

14. A method of filling a tank with gaseous fuel, comprising:
delivering a gas from a filling station to the tank, at a ramp pressure:
communicating a gas temperature measurement (Tgas_high) and a gas pressure measurement from the tank to the filling station;
setting values for a set of parameters (a, b, Tgas_max and Tgas_target);
increasing the ramp pressure at a pressure ramp rate (PRR_calculated) calculated using a predetermined fueling protocol;
computing a pressure drop (DeltaP) as the difference between the ramp pressure (P_ramp) and the tank pressure;
computing a maximum value of the pressure drop (DeltaP_max);
computing a temperature threshold value T_threshold as (DeltaP_max) subtracted from Tgas_target;
in response to the gas temperature being greater than T_threshold:
computing a pressure ramp rate (PRR_threshold);
computing an adaptable denominator (AD) as the maximum value of either “b” or the product of “a” and DeltaP;
computing a new pressure ramp rate (PRR_throttle) as the maximum value of either zero or the product: PRR_threshold times (Tgas_target minus Tgas_high) divided by AD;
comparing PRR_throttle to PRR_calculated; and
in response to PRR_throttle being lower than PRR_calculated, setting the pressure ramp rate to PRR_throttle.

15. The method of claim 14, wherein:
The tank is part of a compressed gas storage system having two or more tanks; and
the gas temperature measurement (Tgas_high) represents the highest gas temperature of all of the two or more tanks in the compressed gas storage system.

16. The method of claim 14, wherein Tgas_target is an offset (DeltaT) lower than Tgas_max, or is a percentage of Tgas_max.

17. The method of claim 14, wherein DeltaP is calculated as the station pressure minus tank pressure.

18. The method of claim 14, further comprising computing T_threshold as DeltaP subtracted from the target temperature (Tgas_target).

19. The method of claim 14, further comprising computing T_threshold as a percentage of Tgas_target.

20. A method of filling a tank with gaseous fuel, comprising:
delivering a gas from a filling station to the tank, at a ramp pressure;
setting values for a set of parameters (a, b_min, TMAL, Tgas_max, Tgas_target, Tgas_smooth_threshold, Tgas_diff_factor, and Tgas_diff_multiplier);
communicating a gas temperature measurement (Tgas_high) and a gas pressure measurement from the tank to the filling station;
increasing the ramp pressure at a pressure ramp rate (PRR_calculated) calculated using a predetermined fueling protocol;
computing a pressure drop (DeltaP) as the difference between the ramp pressure and the tank pressure;
computing a maximum value of the pressure drop (DeltaP_max);
computing a triple moving average of Tgas_high with each moving average having a length of TMAL, referred to as Tgas_smooth;
computing a temperature threshold value T_threshold as the product of DeltaP_max times a constant, subtracted from Tgas_target;
in response to Tgas_smooth being greater than T_threshold:
computing a pressure ramp rate (PRR_threshold);
in response to Tgas_smooth being greater than Tgas_smooth_threshold:
computing Tgas_diff as the difference between Tgas_high and Tgas_smooth;
computing a maximum value of Tgas_diff, defined as Tgas_diff_max;
computing Tgas_offset as the product of Tgas_diff_factor and Tgas_diff_max;
computing Tgas_target as Tgas_max minus Tgas_offset;
computing parameter b as the maximum value of either b_min or the product of Tgas_offset_multiplier and Tgas_offset;
computing an adaptable denominator AD as the maximum value of either parameter b or the product of: parameter a and DeltaP;
computing a new pressure ramp rate (PRR_throttle) as the maximum value of either zero or the product of PRR_threshold multiplied by (Tgas_target minus Tgas_smooth) divided by AD;
comparing PRR_throttle to PRR_calculated; and
in response to PRR_throttle being less than PRR_calculated, setting the pressure ramp rate to PRR_throttle.

21. The method of claim 20, wherein:
The tank is part of a compressed gas storage system having two or more tanks; and
the gas temperature measurement (Tgas_high) represents the highest gas temperature of all of the two or more tanks in the compressed gas storage system.

22. The method of claim 20, wherein T_threshold is computed as the product of DeltaP times a constant, subtracted from Tgas_target.

23. The method of claim 20, wherein T_threshold is computed as a percentage of Tgas_target.
